(19) United States
(12) Patent Application Publication
(10) Pub. No.: US 2009/0174870 A1
(43) Pub. Date: Jul. 9, 2009

(54) Cleaning apparatus and immersion lithographic apparatus

(75) Inventors: Anthonius Martinus Cornelis Petrus De Jong, Pijnacker (NL); Hans Jansen, Eindhoven (NL); Martinus Hendrikus Antonius Leenders, Rhoon (NL); Paul Blom, Veldhoven (NL); Ronald Harm Gunther Kramer, Hooge Mierde (NL); Michel van Putten, Delft (NL); Ariel de Graaf, Utrecht (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/289,621

(22) Filed: Oct. 30, 2008

Related U.S. Application Data
(60) Provisional application No. 61/001,050, filed on Oct. 31, 2007.
(60) Provisional application No. 61/006,951, filed on Feb. 7, 2008.

(51) Int. Cl. G03B 27/52

(52) U.S. Cl. 355/30

(57) ABSTRACT

A cleaning apparatus to clean a substrate or component of an immersion lithographic apparatus is disclosed. The cleaning apparatus may comprise a plasma radical source, a conduit and a radical confinement system. The plasma radical source may provide a flow of radicals. The conduit may supply radicals from the plasma radical source to the surface to be cleaned. The radical confinement system may direct the radicals to clean a localized portion of the surface. The cleaning apparatus may comprise a rotator and may be configured to clean a substrate edge. An immersion lithographic apparatus comprising the cleaning apparatus to clean a surface is also disclosed. The immersion lithographic apparatus may comprise a substrate table to support a substrate and a fluid confinement structure to at least partly confine immersion fluid between a projection system and a substrate table and/or substrate.

This application claims priority and benefit to U.S. Provisional Patent Application Ser. No. 61/001,050, entitled “AN IMMERSION LITHOGRAPHY APPARATUS”, filed on Oct. 31, 2007, and also claims priority and benefit to U.S. Provisional Patent Application Ser. No. 61/006,951, entitled “CLEANING APPARATUS AND IMMERSION LITHOGRAPHIC APPARATUS”, filed on Feb. 7, 2008. The contents of those applications are incorporated herein in their entirety by reference.

### FIELD

The present invention relates to a cleaning apparatus and an immersion lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It has been proposed to immerse the substrate in the lithographic projection apparatus in a liquid having a relatively high refractive index, e.g. water, so as to fill a space between the final element of the projection system and the substrate. The liquid may be distilled water, although another liquid could be used. The description herein references a liquid. However, another fluid may be suitable, particularly a wetting fluid, incompressible fluid and/or a fluid with a higher refractive index than air, desirably a higher refractive index than water, such as a hydrocarbon, such as a hydrofluorocarbon. The point of this is to enable imaging of smaller features since the exposure radiation will have a shorter wavelength in the liquid. (The effect of the liquid may also be regarded as increasing the effective numerical aperture (NA) of the system and also increasing the depth of focus.) Other immersion liquids have been proposed, including water with solid particles (e.g. quartz) suspended therein and particles having the same refractive index as the liquid within which they are suspended. The particles may be of the size of nanoparticles. They may be provided in a concentration that increases the refractive index of the liquid in which they are suspended.

Submersing the substrate or substrate and substrate table in a bath of liquid (see, for example, U.S. Pat. No. 4,509,852) means that there is a large body of liquid that must be accelerated during a scanning exposure. This requires additional or more powerful motors and turbulence in the liquid may lead to undesirable and unpredictable effects.

In an immersion apparatus, immersion fluid is handled by a fluid handling system, structure or apparatus. In an embodiment the fluid handling system may supply immersion fluid and therefore be a fluid supply system. In an embodiment the fluid handling system may at least partly confine immersion fluid and thereby be a fluid confinement system. In an embodiment the fluid handling system may provide a barrier to immersion fluid and thereby be a barrier member, such as a fluid confinement structure. In an embodiment the fluid handling system may create or use a flow of gas, for example to help in controlling the flow and/or the position of the immersion fluid. The flow of gas may form a seal to confine the immersion fluid so the fluid handling structure may be referred to as a seal member; such a seal member may be a fluid confinement structure. In an embodiment, immersion liquid is used as the immersion fluid. In that case the fluid handling system may be a liquid handling system. In reference to the aforementioned description, reference in this paragraph to a feature defined with respect to fluid may be understood to include a feature defined with respect to liquid.

One of the solutions proposed is for a liquid supply system to provide liquid on only a localized area of the substrate and in between the final element of the projection system and the substrate using a liquid confinement system (the substrate generally has a larger surface area than the final element of the projection system). One way which has been proposed to arrange for this is disclosed in PCT patent application publication no. WO 99/49504. As illustrated in FIGS. 2 and 3, liquid is supplied by at least one inlet IN onto the substrate, preferably along the direction of movement of the substrate relative to the final element, and is removed by at least one outlet OUT after having passed under the projection system. That is, as the substrate is scanned beneath the element in a −X direction, liquid is supplied at the +X side of the element and taken up at the −X side. FIG. 2 shows the arrangement schematically in which liquid is supplied via inlet IN and is taken up on the other side of the element by outlet OUT which is connected to a low pressure source. In the illustration of FIG. 2 the liquid is supplied along the direction of movement of the substrate relative to the final element, though this does not need to be the case. Various orientations and numbers of in- and out-lets positioned around the final element are possible; one example is illustrated in FIG. 3 in which four sets of an inlet IN with an outlet OUT on either side are provided in a regular pattern around the final element.

In European patent application publication no. EP 1420300 and United States patent application publication no. US 2004-0136494, the idea of a twin or dual stage immersion lithography apparatus is disclosed. Such an apparatus is provided with two tables for supporting a substrate. Leveling measurements are carried out with a table at a first position, without immersion liquid, and exposure is carried out with a table at a second position, where immersion liquid is present. Alternatively, the apparatus has only one table.

One problem encountered with immersion lithographic machines is the occurrence of contaminating particles within the immersion system and on the surface of the substrate. The presence of a particle in the immersion system may cause defects to occur during the exposure process if the particle is present between the projection system and the substrate being exposed. It is therefore desirable to reduce optimally the presence of particles in the immersion system.

### SUMMARY

It is desirable to provide an immersion lithographic apparatus which is capable of cleaning the surface of the immersion system and/or the substrate.

According to an aspect of the invention, there is provided a cleaning apparatus to clean a substrate or a component of an immersion lithographic apparatus, the lithographic apparatus comprising a substrate table to support a substrate and a fluid confinement system to at least partly confine immersion fluid between a projection system and the substrate table and/or substrate, the cleaning apparatus comprising: a plasma radical source configured to provide a flow of radicals; a conduit to supply radicals from the plasma radical source to the surface to be cleaned; and a radical confinement system to direct the radicals to clean a localized portion of the surface.

According to an aspect of the invention, there is provided an immersion lithographic apparatus comprising: a projection system configured to impart a patterned beam onto a substrate; a fluid confinement structure configured to at least partly confine immersion fluid between the projection system and the substrate and/or a substrate table, the substrate table arranged to support a substrate; and a cleaning apparatus as described above to clean a localized portion of a surface of the fluid confinement structure. The cleaning apparatus is arranged to clean a localized portion of a surface of the fluid confinement structure.

According to an aspect of the invention, there is provided an immersion lithographic apparatus comprising: a projection system configured to impart a patterned beam onto a substrate; a substrate table configured to support the substrate; a fluid confinement structure configured to at least partly confine immersion fluid between the projection system and the substrate and/or substrate table; and a cleaning apparatus as described above to clean a localized portion of a surface of the substrate table. The cleaning apparatus is arranged to clean a localized portion of a surface of the substrate table.

According to an aspect of the invention, the cleaning apparatus may further comprise a substrate rotator configured to rotate a substrate relative to the conduit. The radical confinement system is configured to direct the radicals to a localized portion of the periphery of the substrate such that, by rotation of the substrate relative to the conduit, the complete periphery of the substrate may be cleaned.

According to an aspect of the invention, there is provided a lithographic apparatus comprising: a substrate handler configured to position a substrate on a substrate table, the substrate table configured to support the substrate during exposure and the substrate handler configured to rotate the substrate prior to positioning the substrate on the substrate table; and a substrate cleaner configured to clean a localized portion of a surface of the substrate as the substrate rotates, the substrate cleaner comprising: a plasma radical source configured to provide a flow of radicals, a conduit to supply radicals from the plasma radical source to the surface, and a radical confinement system configured to direct the radicals to clean the localized portion.

According to an aspect of the invention, there is provided a cleaning apparatus to clean a surface of an immersion lithographic apparatus comprising a substrate table to support a substrate and a fluid confinement structure to at least partly confine immersion fluid between a projection system and a substrate table and/or a substrate. The cleaning apparatus comprises a main body, formed of an electrically insulating material and configured to be supported by the substrate table of the immersion lithographic apparatus in place of a substrate, and an electrically conducting region formed such that it is electrically isolated by at least a part of the main body from a surface of the main body that faces the fluid confinement structure when the main body is supported on the substrate table.

According to an aspect of the invention, there is provided an immersion lithographic apparatus comprising: a projection system configured to impart a patterned beam onto a substrate; a substrate table configured to support the substrate; a fluid confinement structure configured to at least partly confine immersion fluid between the projection system and the substrate and/or substrate table; and a voltage supply, configured to supply a voltage between the fluid confinement structure and an electrically conducting region of a main body of a cleaning apparatus when the main body is supported, in place of a substrate, on the substrate table, the cleaning apparatus comprising: the main body, formed of an electrically insulating material, and the electrically conducting region formed such that it is electrically isolated by at least a part of the main body from a surface of the main body that faces the fluid confinement structure when the main body is supported on the substrate table.

According to an aspect of the invention, there is provided an immersion lithographic apparatus comprising: a projection system configured to impart a patterned beam onto a substrate; a substrate table configured to support the substrate; a fluid confinement structure configured to at least partly confine immersion fluid between the projection system and the substrate and/or substrate table; and a voltage supply, configured to supply a voltage between first and second electrically conducting regions of a main body of a cleaning apparatus when the main body is supported, in place of a substrate, on the substrate table, the cleaning apparatus comprising: the main body, formed of an electrically insulating material, the first electrically conducting region formed such that it is electrically isolated by at least a part of the main body from a surface of the main body that faces the fluid confinement structure when the main body is supported on the substrate table, and the second electrically conducting region that is electrically isolated from the first electrically conducting region.

According to an aspect of the invention, there is provided a method for cleaning a substrate or component of an immersion lithographic apparatus, the immersion lithographic apparatus comprising a substrate table configured to support a substrate and a fluid confinement structure configured to at least partly confine immersion fluid between a projection system and the substrate table and/or a substrate, the method comprising: providing a flow of radicals using a plasma radical source; supplying radicals from the plasma radical source to the surface to be cleaned using a conduit; and directing the radicals to clean a localized portion of the surface using a radical confinement system.

According to an aspect of the invention, there is provided a method for cleaning a surface of an immersion lithographic apparatus, the immersion lithographic apparatus comprising a substrate table configured to support a substrate and a fluid confinement structure configured to at least partly confine immersion fluid between a projection system and the substrate table and/or a substrate, the method comprising: supporting on the substrate table, in place of a substrate, a main body of a cleaning apparatus, the cleaning apparatus comprising a plasma radical generator, the plasma radical generator configured to generate radicals within gas in a region adjacent the plasma radical generator; and using the fluid confinement structure to provide a flow of gas between the fluid confinement structure and the substrate table, wherein the flow of gas provided by the fluid confinement structure passes through the region adjacent the plasma radical generator such that a supply of radicals is provided.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2 and 3 depict an embodiment of a liquid supply system used in lithographic projection apparatus;

FIG. 4 depicts an embodiment of a liquid supply system used in a lithographic projection apparatus;

FIG. 5 depicts an embodiment of a liquid supply system;

FIG. 6 depicts features of an embodiment of a liquid supply system;

FIG. 7 depicts an embodiment of a part of an immersion lithographic apparatus and a cleaning apparatus according to an embodiment of the invention;

FIG. 8 depicts an embodiment of a part of an immersion lithographic apparatus and a cleaning apparatus according to an embodiment of the invention;

FIG. 9 depicts an embodiment of part of an immersion lithographic apparatus and a cleaning apparatus according to an embodiment of the invention;

FIG. 10 depicts an embodiment of part of an immersion lithographic apparatus and a cleaning apparatus according to the invention;

FIG. 11 depicts an embodiment of part of a substrate and a cleaning apparatus according to an embodiment of the invention;

FIG. 12 depicts an embodiment of part of a substrate and a cleaning apparatus according to an embodiment of the invention;

FIG. 13 depicts an embodiment of part of a substrate and a cleaning apparatus according to an embodiment of the invention;

FIG. 14 depicts an embodiment of part of an immersion lithographic apparatus and a cleaning apparatus according to an embodiment of the invention;

FIG. 15 depicts an embodiment of a source of radicals according to an embodiment of the invention;

FIG. 16 depicts an embodiment of a cleaning apparatus according to an embodiment of the invention; and

FIG. 17 depicts an embodiment of a cleaning apparatus according to an embodiment of the invention.

### DETAILED DESCRIPTION

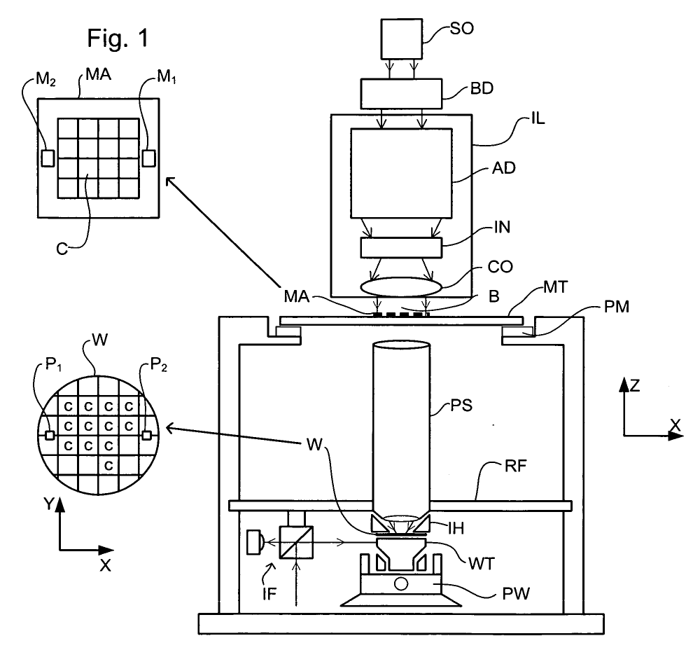

FIG. 1 schematically depicts an embodiment of lithographic apparatus suitable for use with an embodiment of the invention. The apparatus comprises:
an illumination system (illuminator) IL configured to condition a radiation beam B (e.g. UV radiation or DUV radiation);
a support structure (e.g. a mask table) MT constructed to support a patterning device (e.g. a mask) MA and connected to a first positioner PM configured to accurately position the patterning device MA in accordance with certain parameters;
a substrate table (e.g. a wafer table) WT constructed to hold a substrate (e.g. a resist-coated wafer) W and connected to a second positioner PW configured to accurately position the substrate W in accordance with certain parameters; and
a projection system (e.g. a refractive projection lens system) PS configured to project a pattern imparted to the radiation beam B by patterning device MA onto a target portion C (e.g. comprising one or more dies) of the substrate W.

The illumination system IL may include various types of optical components, such as refractive, reflective, magnetic, electromagnetic, electrostatic or other types of optical components, or any combination thereof, for directing, shaping, or controlling radiation.

The support structure MT holds the patterning device MA. It holds the patterning device MA in a manner that depends on the orientation of the patterning device MA, the design of the lithographic apparatus, and other conditions, such as for example whether or not the patterning device MA is held in a vacuum environment. The support structure MT can use mechanical, vacuum, electrostatic or other clamping techniques to hold the patterning device MA. The support structure MT may be a frame or a table, for example, which may be fixed or movable as required. The support structure MT may ensure that the patterning device MA is at a desired position, for example with respect to the projection system PS. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more patterning device tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source SO and the lithographic apparatus may be separate entities, for example when the source SO is an excimer laser. In such cases, the source SO is not considered to form part of the lithographic apparatus and the radiation beam is passed from the source SO to the illuminator IL with the aid of a beam delivery system BD comprising, for example, suitable directing mirrors and/or a beam expander. In other cases the source SO may be an integral part of the lithographic apparatus, for example when the source SO is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as 1-outer and α-inner, respectively) of the intensity distribution in a pupil plane of the illuminator IL can be adjusted. In addition, the illuminator IL may comprise various other components, such as an integrator IN and a condenser CO. The illuminator IL may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device MA. Having traversed the patterning device MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the support structure MT and the substrate table WT are kept essentially stationary, while an entire pattern imparted to the radiation beam B is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam B is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion C in a single dynamic exposure, whereas the length of the scanning motion determines the height (in the scanning direction) of the target portion C.

3. In another mode, the support structure MT is kept essentially stationary holding a programmable patterning device, and the substrate table WT is moved or scanned while a pattern imparted to the radiation beam B is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

An immersion lithography solution with a localized liquid supply system is shown in FIG. 4. Liquid is supplied by two groove inlets IN on either side of the projection system PS and is removed by a plurality of discrete outlets OUT arranged radially outwardly of the inlets IN. The inlets IN and OUT can be arranged in a plate with a hole in its centre and through which the projection is project. Liquid is supplied by one groove inlet IN on one side of the projection system PS and removed by a plurality of discrete outlets OUT on the other side of the projection system PS, causing a flow of a thin film of liquid between the projection system PS and the projection system PS and removed by a plurality of discrete outlets OUT on the other side of the projection system PS, causing a flow of a thin film of liquid between the projection system PS and the substrate W. The choice of which combination of inlet IN and outlets OUT to use can depend on the direction of movement of the substrate W (the other combination of inlet IN and outlets OUT being inactive).

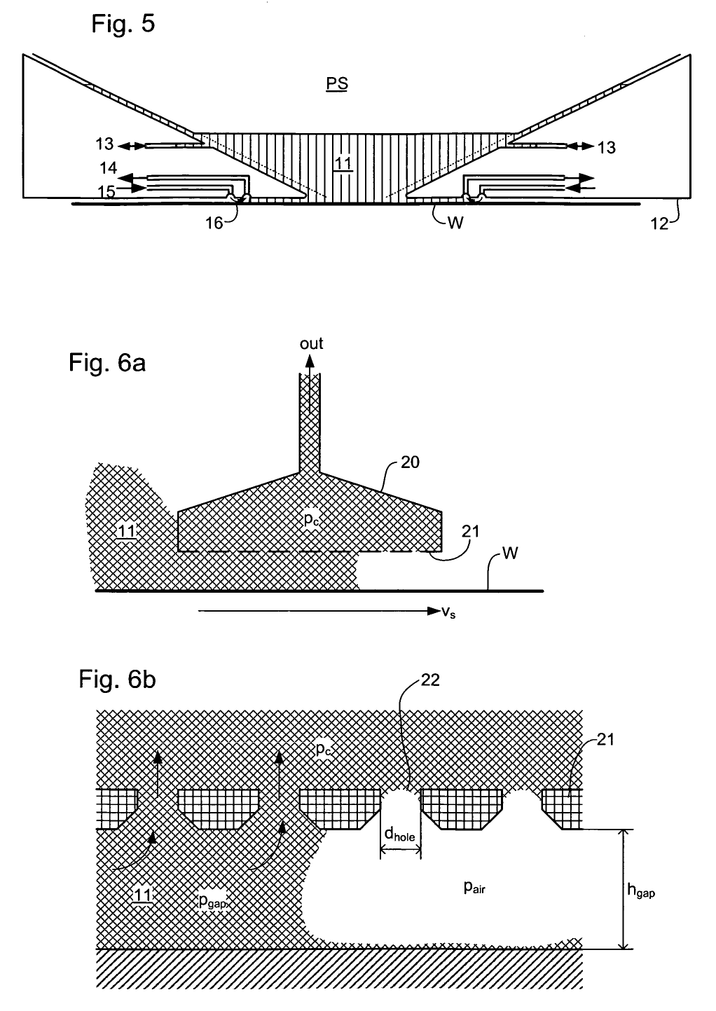

Another immersion lithography solution with a localized liquid supply system solution which has been proposed is to provide the liquid supply system with a liquid confinement structure (or so-called immersion hood) which extends along at least a part of a boundary of the space between the final element of the projection system and the substrate table. Such a solution is illustrated in FIG. 5. The liquid confinement structure is substantially stationary relative to the projection system PS in the XY plane though there may be some relative movement in the Z direction (in the direction of the optical axis). A seal is formed between the liquid confinement structure and the surface of the substrate W. In an embodiment, the seal is a contactless seal such as a gas seal.

Referring to FIG. 5, a liquid confinement structure 12 forms a contactless seal to the substrate W around the image field of the projection system PS so that liquid is confined to fill a reservoir or an immersion space 11 between the substrate surface and the final element of the projection system PS. The reservoir 11 is formed by a liquid confinement structure 12 positioned below and surrounding the final element of the projection system PS. Liquid is brought into the space 11 below the projection system PS and within the liquid confinement structure 12. The liquid confinement structure 12 extends a little above the final element of the projection system PS and the liquid rises above the final element so that a buffer of liquid is provided. The liquid confinement structure 12 has an inner periphery that at the upper end, in an embodiment, closely conforms to the shape of the projection system PS or the final element thereof and may, e.g., be round. At the bottom, the inner periphery closely conforms to the shape of the image field, e.g., rectangular though this need not be the case.

The liquid is confined in the reservoir 11 by a gas seal 16 between the bottom of the liquid confinement structure 12 and the surface of the substrate W. The gas seal 16 is formed by gas, e.g. air or synthetic air but, in an embodiment, N₂ or another inert gas, provided under pressure via inlet 15 to the gap between liquid confinement structure 12 and substrate W and extracted via first outlet 14. The overpressure on the gas inlet 15, vacuum level on the first outlet 14 and geometry of the gap are arranged so that there is a high-velocity gas flow inwards that confines the liquid. Such a system is disclosed in United States patent application publication no. US 2004-0207824.

Other solutions are possible and one or more embodiments of the present invention are equally applicable to those. For example, in place of the gas seal 16 it is possible to have a single phase extractor which only extracts liquid. Radially outwardly of such a single phase extractor could be one or more features to produce a gas flow to help contain the liquid in the space 11. One such type of feature might be a so-called gas knife in which a thin jet of gas is directed downwards onto the substrate W. During scanning motion of the substrate W under the projection system PS and the liquid supply system, hydrostatic and hydrodynamic forces may be generated which result in pressures on the liquid downwards towards the substrate W.

With a localized area liquid supply system, the substrate W is moved under the projection system PS and the liquid supply system. The relative movement of the table may be to enable an edge of the substrate W to be imaged or a sensor on the substrate table WT to be imaged for sensing purposes or for substrate swap. Substrate swap is removal and replacement of the substrate W from the substrate table WT between exposures of different substrates. During substrate swap it may be desirable for liquid to be kept within the fluid confinement structure 12. This is achieved by moving the fluid confinement structure 12 relative to the substrate table WT, or vice versa, so that the fluid confinement structure 12 is placed over a surface of the substrate table WT away from the substrate W. Such a surface is a shutter member. Immersion liquid may be retained in the fluid confinement structure 12 by operating the gas seal 16 or by clamping the surface of the shutter member to the undersurface of the fluid confinement structure 12. The clamping may be achieved by controlling the flow and/or pressure of fluid provided to the undersurface of the fluid confinement structure 12. For example, the pressure of gas supplied from the inlet 15 and/or the under pressure exerted from the outlet 14 may be controlled.

The surface of substrate table WT over which the fluid confinement structure 12 is placed may be an integral part of the substrate table WT or it may be a detachable and or replaceable component of the substrate table WT. Such a detachable component may be referred to as closing disc or a dummy substrate. The detachable or separable component may be a separate stage. In a dual or multi stage arrangement the entire substrate table WT is replaced during substrate exchange. In such an arrangement the detachable component may be transferred between substrate tables. The shutter member may be an intermediate table that may be moved adjacent to the substrate table WT prior to substrate exchange. The fluid confinement structure 12 may then be moved onto the intermediate table, or vice versa during substrate exchange. The shutter member may be a moveable component of the substrate table WT, such as a retractable bridge, which may be positioned between the stages during substrate exchange. The surface of the shutter member may be moved under the fluid confinement structure 12, or vice versa, during substrate exchange.

During substrate swap, an edge of the substrate W will pass under the space 11 and liquid may leak into the gap between the substrate W and substrate table WT. This liquid may be forced in under hydrostatic or hydrodynamic pressure or the force of a gas knife or other gas flow creating device. A drain may be provided around the edge of a substrate W, such as in the gap. A drain may be located around another object on the substrate table WT. Such an object may include, but is not limited to, one or more sensors and/or a shutter member used to maintain liquid in the liquid supply system by being attached to the bottom of the liquid supply system during, for example, substrate swap. Thus, any reference to the substrate W should be considered to be synonymous with any such other object, including a sensor or shutter member, such as a closing plate.

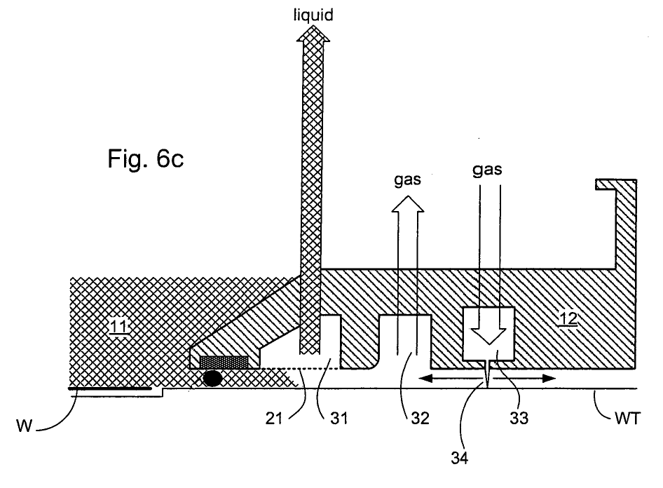

FIGS. 6a and 6b, the latter of which is an enlarged view of part of the former, illustrate a liquid removal device 20 which may be used in an immersion system to remove liquid between the immersion hood IH and the substrate W. The liquid removal device 20 comprises a chamber which is maintained at a slight underpressure p_{c} and is filled with the immersion liquid. The lower surface of the chamber is formed of a porous member 21 having a plurality of small holes 22, e.g. of diameter dₕₒₗₑ in the range of 5 to 50 μm, and is maintained at a height h_{gap} less than 1 mm, desirably in the range of 50 to 300 μm above a surface from which liquid is to be removed, e.g. the surface of a substrate W. The porous member 21 may be a perforated plate or any other suitable structure that is configured to allow the liquid to pass there through. In an embodiment, porous member 21 is at least slightly liquidphilic (e.g., hydrophilic), i.e. having a contact angle of less than 90° to the immersion liquid, e.g. water.

Such a liquid removal device can be incorporated into many types of liquid confinement structure 12 or immersion hood IH. One example is illustrated in FIG. 6c as disclosed in United States patent application publication no. US 2006-0038968. FIG. 6c is a cross-sectional view of one side of the liquid confinement structure 12, which forms a ring (as used herein, a ring may be circular, rectangular or any other shape and it may be continuous or discontinuous) at least partially around the exposure field of the projection system PS (not shown in FIG. 6c). In this embodiment, the liquid removal device is formed by a ring-shaped chamber 31 near the innermost edge of the underside of the liquid confinement structure 12. The lower surface of the chamber 31 is formed by a porous member 21 such as the porous member described above. Ring-shaped chamber 31 is connected to a suitable pump or pumps to remove liquid from the chamber 31 and maintain the desired underpressure. In use, the chamber 31 is full of liquid but is shown empty here for clarity.

Outward of the ring-shaped chamber 31 may be a gas extraction ring 32 and a gas supply ring 33. The gas supply ring 33 may have a narrow slit in its lower part and is supplied with gas, e.g. air, artificial air or flushing gas, at a pressure such that the gas escaping out of the slit forms a gas knife 34. The gas forming the gas knife 34 is extracted by a suitable vacuum pump connected to the gas extraction ring 32 so that the resulting gas flow drives any residual liquid inwardly where it can be removed by the liquid removal device and/or the vacuum pump, which should be able to tolerate vapor of the immersion liquid and/or small liquid droplets. However, since the majority of the liquid is removed by the liquid removal device, the small amount of liquid removed via the vacuum system does not cause unstable flows which may lead to vibration.

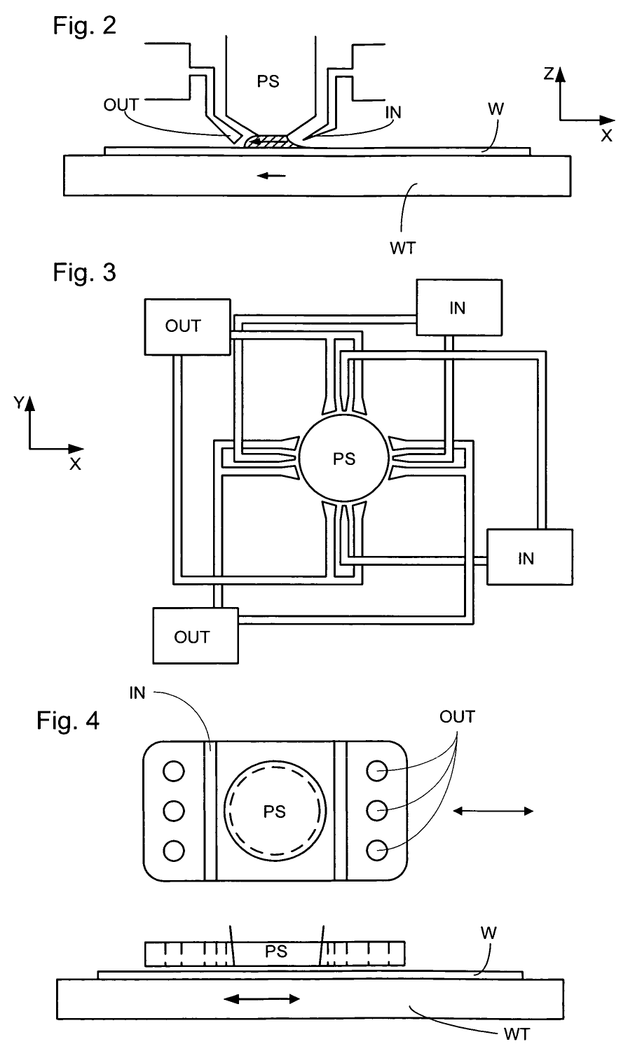

While the chamber 31, gas extraction ring 32, gas supply ring 33 and other rings are described as rings herein, it is not necessary that they surround the exposure field or be complete. They may be continuous or discontinuous. In an embodiment, such inlet(s) and outlet(s) may simply be any annular shape such as circular, rectangular or other type of elements extending partially along one or more sides of the exposure field, such as for example, shown in FIGS. 2, 3 and 4.

In the apparatus shown in FIG. 6c, most of the gas that forms the gas knife 34 is extracted via gas extraction ring 32, but some gas may flow into the environment around the immersion hood and potentially disturb the interferometric position measuring system IF. This can be prevented by the provision of an additional gas extraction ring outside the gas knife (not illustrated).

Further examples of how such single phase extractors can be used in an immersion hood or fluid confinement system or liquid supply system can be found, for example in European patent application publication no. EP 1,628,163 and United States patent application publication no. US 2006-0158627. In most applications the porous member will be on an underside of the liquid supply system and the maximum speed at which the substrate W can move under the projection system PS is at least in part determined by the efficiency of removal of liquid through the porous member 21.

A single phase extractor can also be used in two phase mode in which both liquid and gas are extracted (say 50% gas, 50% liquid). The term single phase extractor is not intended herein to be interpreted only as an extractor which extracts one phase, but more generally as an extractor which incorporates a porous member through which gas and/or liquid is/are extracted. In an embodiment, the gas knife (i.e. the gas supply ring 33) may be absent.

The above mentioned single phase extractor can be used in liquid supply systems which supply liquid to only a localized area of the top surface of the substrate. Furthermore, such an extractor can be used in other types of immersion apparatus. Also the extractor can be used for an immersion liquid other than water. The extractor can be used in a so-called “leaky seal” liquid supply system. In such a liquid supply system liquid is provided to the space between the final element of the projection system and the substrate. That liquid is allowed to leak from that space radially outwardly. For example, an immersion hood or fluid confinement system or liquid supply system is used which does not form a seal between itself and the top surface of the substrate or substrate table, as the case may be. The immersion liquid may only be retrieved radially outwardly of the substrate in a “leaky seal” apparatus. The comments made in relation to a single phase extractor may apply to other types of extractor, for example, an extractor without a porous member. Such an extractor may be used as a two phase extractor to extract both liquid and gas.

An embodiment of the present invention will be described in relation to a lithographic apparatus having an immersion system with a liquid handling system and drain as described in the aforementioned figures. However, it will be apparent that an embodiment of the present invention can be applied to any sort of immersion apparatus. In particular an embodiment of the present invention is applicable to any immersion lithographic apparatus in which defectivity is a problem which it is desirably reduced and desirably minimized. The systems and components described in the earlier passages of the description are thus example systems and components. An embodiment of the invention may apply to other features of the immersion system including, but not limited to, a cleaning system or cleaning tool for in-line or off-line implementation; a liquid supply or liquid retrieval system such as an ultra pure water supply system; or a gas supply or removal system (e.g. a vacuum pump).

An embodiment of the present invention will be described below in relation to an immersion system optimized for supplying an immersion liquid. However, an embodiment of the present invention is equally applicable for use with an immersion system that uses a fluid supply system supplying a fluid other than a liquid as the immersion medium.

In immersion lithographic systems, contamination, especially organic contamination, may build up. This influences the number of defects in a pattern formed on a substrate. The functionality of an immersion lithographic system, such as meniscus stability of the single phase extractor, may be influenced by contaminant aggregation. A variety of different methods are being developed to clean an immersion system to remove the contamination with a minimal down time. Some of these techniques, for example, require cleaning chemicals that have a number of drawbacks which may impact on damage to the immersion system, tool design, safety, and/or cleaning time (for example because of rinsing).

Cleaning using a flow of radicals generated by a plasma radical source, may remove most, if not substantially all, organic materials on the surface being cleaned. Such cleaning may be referred to as plasma cleaning or atmospheric plasma cleaning. However, the cleaning is not selective. Furthermore, an immersion system has many sensitive components. The use of plasma technology to clean an immersion system, especially in-line, for example, installed within a lithographic apparatus so that cleaning can take place without removing one or more components, has previously been considered unfavorable because of all the potential damage risks.

In an embodiment, atmospheric plasma techniques may be used to clean a contaminated surface. Unexpectedly, if conditions are carefully selected, for example, using a damage limitation measure, atmospheric plasma cleaning may be used successfully in a complex immersion lithographic environment.

The plasma may generate an activated species that may be directed in a gas flow directed towards a contaminated surface. The activated species is a short living radical that is active over a short distance. The plasma may be used to generate radicals in a plasma region. A flow of gas may be provided through a plasma region to generate the radicals that may be used for cleaning. A three dimensional surface may be readily cleaned, the activated species flowing over the surface to be cleaned. Surfaces suitable for cleaning include the immersion system and a substrate edge before it is placed on the substrate table. Rinsing may be unnecessary because, apart from the species generated in the plasma, chemicals are not used.

To avoid or reduce damage several strategies can be applied according to an embodiment of the present invention. These include: appropriately selecting a reductive plasma or an oxidative plasma depending on the surface desired to be cleaned, noting that a reductive plasma (i.e. unlike an oxidative plasma) generates radicals which may not damage metals or etch glass; avoiding surfaces sensitive to the radicals; preventing the radicals from accessing some surfaces by using a protective gas flow and/or providing a physical barrier to prevent the radicals from reaching sensitive surfaces; using a radio frequency generated plasma, which may result in a lower temperature gas flow than other forms of generating a plasma; or supplying a gas flow from which ions have been removed and/or which only provides a flow of radicals. In an example, a flow of gas, at a temperature of below 60 degrees Celsius, onto a surface may remove 100 to 200 nm of contaminants per minute. Furthermore, temperature effects may be reduced by using short contact times on a surface or pulsing the plasma radical source.

The cleaning technique may be a simple and fast method enabling mainly organic contamination to be removed, including from sensitive surfaces. The method may be used to remove resist like contamination and other types of contamination which may be difficult to remove (for example partly carbonized contamination).

The cleaning technique may use radicals generated from oxygen (oxidative plasma) or hydrogen (reductive plasma) in an inert gas. The inert gas may be, for example, nitrogen or a noble gas, such as neon, argon, xenon or helium. The inert gas may be mixed with an active gas. The active gas may be hydrogen and/or oxygen. In an embodiment of oxidative plasma, the inert gas may be mixed with, or may be, air.

In order to generate the radicals, the gas, including a combination of an inert gas and an active gas may be passed through a plasma generating region in which radicals may be formed from the active gas. The plasma generating region may be part of the plasma radical source. It will be appreciated that the gas source providing the flow of gas to the plasma generating region may be provided at some distance from the plasma generating region.

The plasma generating region may include a high temperature element located within a path of the flow of gas. The temperature of such a high temperature element should be sufficient to cause thermal dissociation in order to create radicals. Such an arrangement may, in particular, be used with a flow of air or purified air in order to provide oxygen radicals for cleaning.

In an arrangement, the plasma generating region may include at least one selected from the following: a RF coil, a pair of AC or DC discharge electrodes or a microwave or RF cavity configured to generate a region of plasma within the flow of gas provided from the gas source. Radicals may be formed in the plasma region. In such an arrangement, the concentration of the active gas may be low, for example it may be between approximately 0.5% and approximately 2% of the gas supplied by the gas source. In a particular arrangement, the active gas may be approximately 1% of the gas supplied by the gas source.

In a particular arrangement, a conduit supplies radicals from the plasma radical source to the surface to be cleaned. The plasma radical source and the conduit may be configured such that substantially no ions are provided from the conduit to the surface to be cleaned. In particular, this may be achieved by ensuring that the conduit is sufficiently long so that the majority, if not all, of the ions formed in the plasma generating region collide with a surface of the conduit or with other plasma and/or gas species and are therefore removed. Such an arrangement may be desirable because the ions may cause damage to the surface to be cleaned. The cleaning apparatus may be arranged to provide a flow of radicals to the surface to be cleaned without including a significant number of ions within the flow.

In a particular arrangement, the plasma generating region may be located between approximately 1 mm and approximately 30 mm from the surface to be cleaned. The outlet of the conduit may be as close as 0.1 mm, for example, from the surface to be cleaned. However a greater distance may facilitate a cleaning process, for example, if the surface to be cleaned has a three-dimensional shape and the conduit outlet is to be scanned above the surface. The arrangement may be selected to provide a sufficient length of conduit for the ions to be removed from the flow or reduced to a desirable level. At the same time, the number of radicals within the flow may not be reduced to below a level at which the cleaning ceases to be sufficiently effective. The desired distance between the plasma radical source and the surface to be cleaned may depend on the design of the conduit, for example the design of the conduit outlet.

It should be noted that, where a sensitive surface is to be cleaned, such as a sticker, or a coating comprising an organic or metal oxide, a reductive plasma may be preferred to an oxidative plasma. A reductive plasma does not cause oxidative damage. A suitable reductive plasma comprises hydrogen.

The temperature of the gas flow when it is applied to the surface to be cleaned may be between 50-100° C. If a RF source is used to generate a plasma, the gas flow applied to the surface may, for example, be approximately 60° C. If a thermal source is used to generate a plasma, the temperature of the gas flow applied to the surface may be approximately 100° C.

Accordingly, the use of a RF source may be beneficial because the temperature of the gas flow applied to the surface to be cleaned may be lower, reducing the heating on the surface. This may be beneficial because a heat load on a sensitive surface within an immersion lithographic apparatus may result in damage. Alternatively or additionally, once the cleaning process is completed, if there has been significant heating of any components, it may be necessary to wait until the components have cooled before lithography processing can be resumed. Accordingly, heating of components within the lithographic apparatus may result in additional loss of exposure processing time beyond the time required to perform the cleaning process.

It should be appreciated that the temperature of the gas flow provided to the surface to be cleaned may be higher if a thermal source is used to generate a plasma than if a RF source is used. However, the gas flow in that case may include a larger number of radicals than if a RF source is used. Accordingly, the time for which the gas flow must be provided to a surface in order to remove a desired amount of contaminants may be lower than the time that would be required for a radical cleaning process using a RF source. Accordingly, by applying a higher temperature gas flow for a smaller amount of time, the total heat load applied to the surface during the cleaning process may be the same or smaller.

Regardless of the means used to generate the flow of radicals for cleaning, it will be appreciated that the amount of time that the gas flow is applied to the surface to be cleaned should be minimized. Thus, the surface to be cleaned may not be warmed up dramatically. With a short effective contact time per unit area, the heat load may be minimal, minimizing the possible damage that could be caused to the surface.

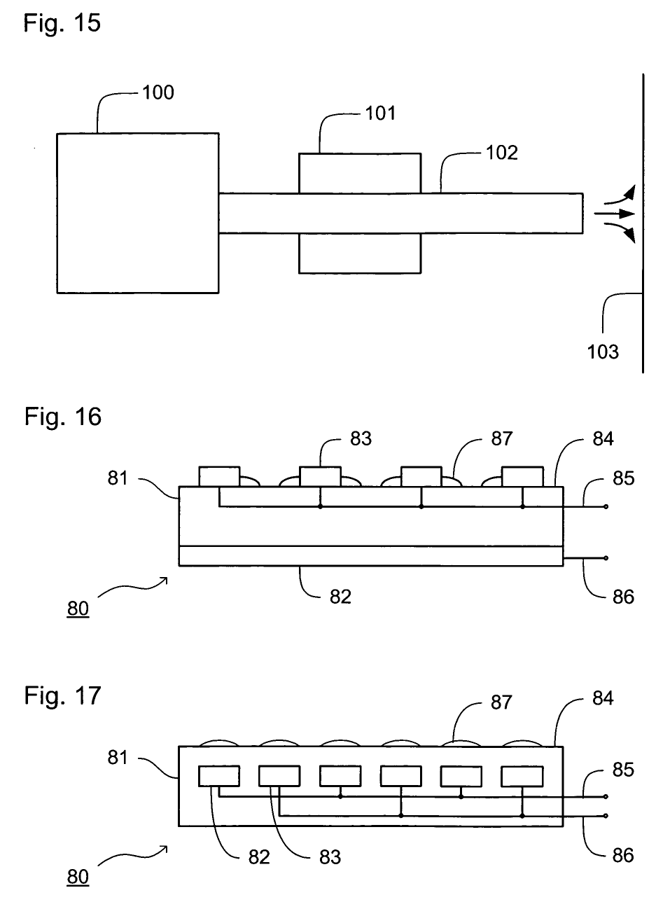

FIG. 15 schematically depicts a source of radicals that may be used as part of a cleaning apparatus of an embodiment of the invention. As shown, a gas source 100 provides a flow of gas that passes through a plasma generating region 101 in which radicals may be formed and is directed by a conduit 102 onto a surface 103 to be cleaned. As discussed above, the plasma generating region 101 may include at least one selected from the following: a high temperature element located within the flow of gas, a RF coil, a pair of AC or DC discharge electrodes or a microwave or RF cavity.

The active gas is active only in a limited space due to the short lifetime of the radicals. Therefore, the conduit outlet may be located between approximately 1 mm and approximately 30 mm from the surface to be cleaned. More desirably, the distance between the surface and the conduit outlet may be in the range of approximately 10 mm to 20 mm.

The cleaning apparatus according to an embodiment of the present invention, may, in particular, be a so-called atmospheric plasma cleaner. It may also be referred to as a plasma cleaner. In such an arrangement, the flow of gas from the plasma cleaner, including the radicals which are to be used for the cleaning process, is output into a space at substantially atmospheric pressure. In particular, therefore, the space does not need to be evacuated. Beneficially, therefore, the cleaning apparatus may be used with minimal preparation time because, for example, it is not necessary to evacuate a space before the cleaning process can commence. It will be appreciated that the gas supply providing a flow of gas to the plasma cleaner should provide the gas at a higher pressure than the pressure of the space in which the plasma cleaner is operating.

An embodiment of the present invention may be a cleaning apparatus configured to clean a substrate or a component of an immersion lithographic apparatus. The immersion lithographic apparatus may comprise a substrate table and a fluid confinement system. The substrate table may support a substrate. The fluid confinement system may at least partly confine immersion fluid between a projection system and substrate table, a substrate or both. The cleaning apparatus may comprise: a plasma radical source, a conduit and a radical confinement system. The plasma radical source provides a flow of radicals. The plasma radical source may be configured to supply a source of reducing radicals or oxidizing radicals. The plasma radical source may be configured to remove ions from the flow of radicals. Desirably, radicals are the only active component supplied by the radical flow. The conduit is configured to supply radicals from the plasma radical source to the surface to be cleaned. The radical confinement system is configured to direct the radicals to clean a localized portion of the surface.

Since the radicals are directed at a localized portion of a surface to be cleaned, the radicals are directed at a single portion for a short duration of time. This is to enable different portions of the surface to be cleaned. Thus the portions may be changed so that substantially the whole surface can be cleaned. A short contact time is desirable because the surface to be cleaned does not warm up significantly, minimizing the risk of damage to the surface.

The radical confinement system may comprise a barrier member. Accordingly, the flow of radicals to sensitive components may be prevented or restricted. The radical confinement system may be configured to provide a flow of gas to the localized portion of the surface, for example away from sensitive components. The radical confinement system may be configured to provide the flow of gas so as to limit the radicals substantially to the same side of the barrier member as the localized portion of the surface. The barrier member may be a radical confinement chamber within which an outlet of the conduit is located. Accordingly, the radicals may be contained within the chamber, preventing or reducing their flow to sensitive components that may be located outside the chamber.

The radical confinement chamber may comprise an outlet connected to an under pressure source. Accordingly, the pressure within the radical confinement chamber may be lower than the surrounding region of the lithographic apparatus. At a gap that may exist between an edge of the radical confinement chamber and the surface to be cleaned, gas will tend to flow into the radical confinement chamber. The flow of any radicals from within the radical confinement chamber to outside of the radical confinement chamber where sensitive components of the lithographic apparatus may be located, may be reduced or prevented.

The radical confinement system may be specifically configured to form a gas flow to direct the radicals. In particular, the radical confinement system may include a gas outlet and a gas exhaust. The radical confinement system may be arranged such that the gas outlet provides a flow of gas towards a portion of the surface to be cleaned on which the flow of radicals from the conduit is directed. The flow of gas is directed so as to prevent the flow of radicals from the conduit flowing towards a different part of the surface that may, for example, include a sensitive component. The gas exhaust may be arranged to extract gas, for example gas flowing from the conduit of the cleaning apparatus after it has been directed towards the surface to be cleaned and/or gas provided by the gas outlet of the radical confinement system. It will be appreciated, however, that a dedicated gas exhaust may not be required.

The following description refers to exemplary embodiments of a plasma cleaner 42 or a cleaning apparatus for a surface of the immersion system. The specific embodiments described relate to a plasma cleaner for a fluid confinement structure 12 (also known as an immersion hood) and a substrate table WT. Each of them may embody a cleaning apparatus previously described.

The plasma cleaner 42 may have a volume of less than a liter, more desirably, less than 0.5 liters, enabling it to be readily fitted to a lithographic apparatus. The plasma cleaner 42 may be used in an off-line embodiment or an in-line embodiment, may be used to clean a surface within a lithographic apparatus without removing one or more components of the lithographic apparatus and/or without suspending the use of the lithographic apparatus for exposures for a significant amount of time. Alternatively or additionally, it may be used to perform cleaning processes while the use of the lithographic apparatus is suspended.

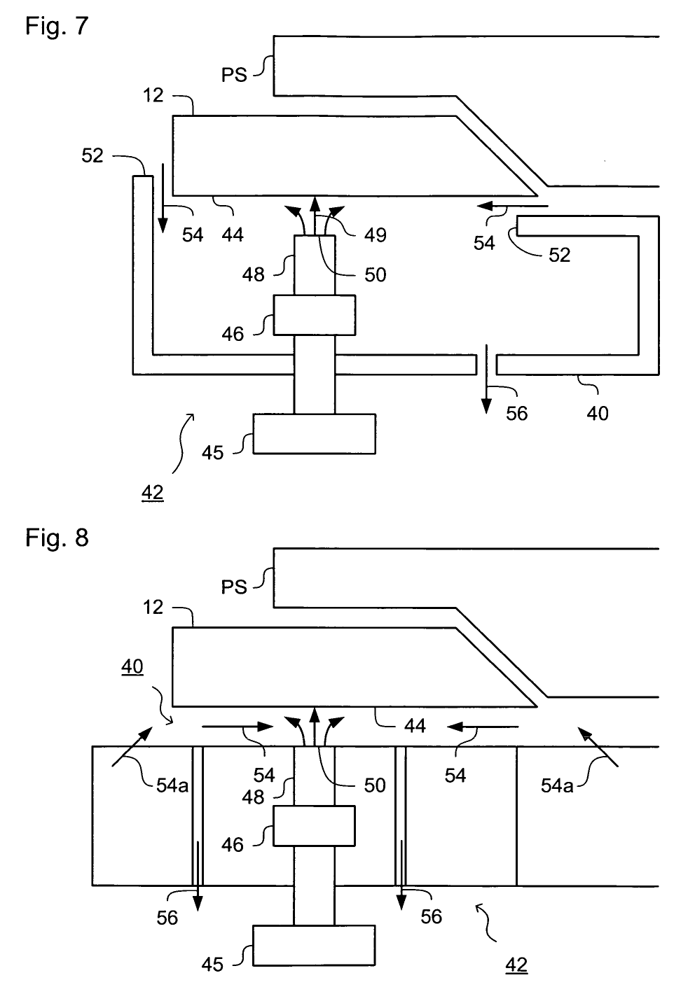

The plasma cleaner 42 may be mounted under the fluid confinement structure 12 to clean a surface of the liquid confinement structure 12 such as its undersurface 44, as shown in FIG. 7. This may be an off-line embodiment. In an in-line embodiment, the plasma cleaner 42 may be located in a sensor recess or designated station located in the substrate table WT, as shown in FIG. 8.

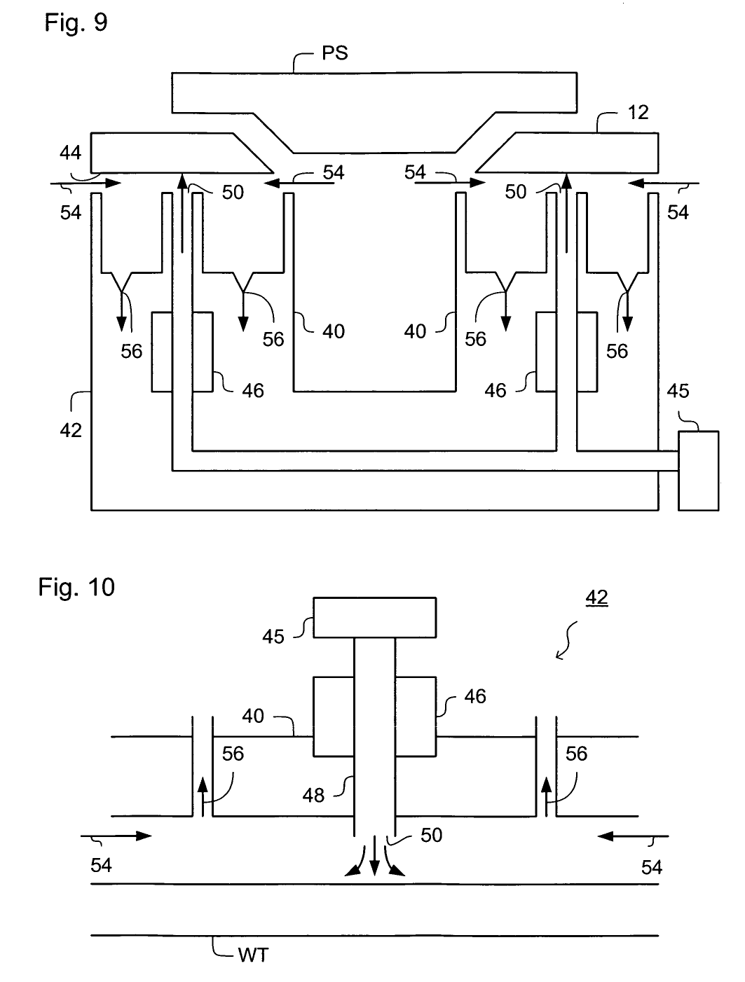

FIG. 9 shows a rotatable plasma cleaner 42 for cleaning the undersurface 44 of the fluid confinement structure 12. This may be implemented in an in-line embodiment or an off-line embodiment as shown in FIGS. 7 and 8. The plasma cleaner 42 may be mounted to an immersion lithographic apparatus to clean the surface of a substrate table WT, as shown in FIG. 10. This may be an in-line or an off-line implementation. In a variation of this embodiment, the plasma cleaner 42 may be integrated into a fluid confinement structure 12, so that an outlet 50 of a plasma cleaner conduit 48 may be directed to a localized surface of the substrate table WT.

As explained above, a cleaning apparatus according to an embodiment of the present invention may be installed in an immersion lithographic apparatus. Such an apparatus may in particular comprise a projection system, an immersion fluid confinement structure and a substrate table to support a substrate. The projection system may be configured to impart a patterned beam onto a substrate. The immersion fluid confinement structure may be configured to at least partly confine an immersion fluid between the projection system and the substrate or a substrate table. The cleaning apparatus may have the features of a plasma cleaner as previously described and may be arranged to clean a localized portion of a surface of the fluid confinement structure. The cleaning apparatus may be an integral part of the immersion lithographic apparatus.

The cleaning operation may occur while the fluid confinement structure is installed within the immersion lithographic apparatus. The radical confinement system of the cleaning apparatus may, in particular, be configured to prevent radicals from being directed onto an element of the projection system. This may be important because an element of the projection system may be susceptible to damage by a plasma cleaner and any such damage may degrade the performance of the projection system.

The substrate table may be configured such that the substrate table can be removed from the region adjacent the fluid confinement structure and the projection system. When the substrate table is removed from the region, the cleaning apparatus may be operable to clean the localized portion of a surface of the fluid confinement structure.

In a configuration, the plasma cleaner may be mounted to an actuator system. The plasma cleaner may be arranged such that it can advance to the surface to be cleaned of the fluid confinement structure. The plasma cleaner may be moved towards the fluid confinement structure once the substrate table is removed from the region adjacent the fluid confinement structure.

Alternatively or additionally, for example, at least an outlet of the conduit of the cleaning apparatus may be installed within the substrate table. Accordingly, the cleaning apparatus may be moved relative to the fluid confinement structure by movement of the substrate table. The cleaning apparatus may, for example, be installed within the substrate table in a location such that, when the substrate table is supporting a substrate, the substrate is located on top of the cleaning apparatus. Accordingly, when the substrate table is supporting a substrate, the cleaning apparatus does not interfere with the normal operation of the immersion lithographic apparatus. However, when the substrate table is not supporting a substrate, the substrate table may be moved as required to position the cleaning apparatus as necessary to clean a desired portion of a surface of the fluid confinement structure. In an embodiment, the cleaning apparatus may be located in the substrate table away from the location of the substrate table that supports the substrate. Such a location may be an opening in the substrate table for a sensor.

The immersion fluid confinement structure may surround an element of the projection system. The cleaning apparatus may be configured to clean a band on a surface of the immersion fluid confinement structure that may surround the element of the projection system. The band may be an annular region of the surface of the immersion fluid confinement structure. The outlet of the conduit supplying the radicals may be configured to conform to the shape of the band to be cleaned. One or more plasma radical sources may be arranged to provide radicals to the conduit.

FIG. 7 depicts an embodiment of a cleaning apparatus 42 to clean a surface of a fluid confinement structure 12 which may, in particular, be off-line. In operation, a gas flow from a gas source 45 may pass through a plasma radical source 46. The plasma radical source 46 may be located in a plasma head in which a region of plasma is generated as discussed above. The gas flow may entrain radicals generated by the plasma radical source 46. The gas flow may pass through a conduit 48. The conduit 48 may direct the gas flow to a localized under surface 44 of the fluid confinement structure 12 being cleaned. In this way, the gas knife extractor, and/or gas knife, and/or single phase extractor may be cleaned. As described above, the conduit may be configured to be sufficiently long so as to remove ions from the gas flow before the gas flow is used for cleaning. If ions are present in the gas flow, the ions may damage the surface being cleaned.

The conduit 48 may have an outlet 50 by which the gas flow 49 is directed to the localized surface. The outlet 50 may be positioned 5 to 20 mm from the surface being cleaned. The outlet 50 may be located in a radical confinement system 40.

The radical confinement system 40 may comprise a chamber which may enclose the environment in which the cleaning apparatus operates. One or more edges 52 of the radical confinement system 40 may act as a barrier member to restrict the flow of the plasma generated radicals over the surface of the fluid confinement structure 12 by physically blocking the flow.

Additionally or in the alternative, a gas flow 54 between one or more of the edges 52 and the fluid confinement structure 12 may be used to restrict the radicals to a localized surface of the fluid confinement structure 12. The gas flow 54 may limit the radicals substantially to the same side of the barrier member as the localized portion of the surface. The chamber may comprise one or more outlets 56 connected to an under pressure source to extract gas from the chamber and to control the flow of the radicals.

It will be appreciated that the provision of the under pressure source, extracting gas from the chamber, may be sufficient to lower the pressure within the chamber below the pressure in the remainder of the immersion lithographic apparatus. Accordingly, the pressure difference established by the under pressure source connected to the outlet 56 may establish the gas flow 54 between the one or more edges 52 of the chamber and the fluid confinement structure 12. Alternatively or additionally, separate gas sources may be provided having appropriately placed outlets in order to establish the gas flow 54. Together these features act as an active cover of, e.g., a final element of the projection system. Any impact of active species on the final element of the projection system PS, which may be adjacent the immersion confinement structure, may thus be avoided. Additionally or alternatively, a passive, physical cover may be used.

In an off-line embodiment, the cleaning apparatus 42 may be mounted to the immersion system using three connection points, which may be near the final element of the projection system PS. In such an arrangement the substrate table WT is removed from the immersion lithographic apparatus first or, at least, moved away from the projection system.

The cleaning apparatus 42 may, as described above, be arranged such that the outlet 50 of the conduit is annular, e.g. ring-shaped, such that it may simultaneously clean a band, for example an annular band, on the surface of the fluid confinement structure. This may be beneficial because contaminants on the fluid confinement structure may, in particular, build up on such an annular band. The annular band may correspond to the location of a component of the fluid confinement structure, for example, porous member 21.

Alternatively or additionally, the components of the cleaning apparatus 42 may be mounted to an actuator system or to the substrate table such that the outlet 50 of the conduit 48 may be moved to the desired locations to clean at least a part of the surface of the fluid confinement structure 12. In such an arrangement, the outlet 50 of the conduit 48 may be relatively small. This may permit the use of a smaller plasma generating region but may require the cleaning apparatus 42 to be moved in order to clean all of the areas of the under surface 44 of the fluid confinement structure 12 that may require cleaning. The actuator system and/or substrate table may be connected to a controller. Thus, the cleaning apparatus may be controlled to select the surface of the confinement structure to be cleaned.

Alternatively or additionally, components of the cleaning apparatus 42 may be configured to rotate about an axis. The outlet 50 of the conduit 48 may be rotated through part of or a complete revolution of 360 degrees in order to provide cleaning to part of or substantially all of an annular band on the under surface 44, for example the surface of the porous member 21. The cleaning apparatus may be connected to a controller arranged to control the rotation of the cleaning apparatus. Thus, by operating the controller, the surface cleaned may be selected.

The complete undersurface 44 of the fluid confinement structure 12 may be cleaned by any or all of the means discussed above.

In an embodiment, a reductive plasma may be used to generate the radicals so as to avoid oxidation of a feature such as the single phase extractor or a coating. The contact time may be limited to avoid damage caused by over-heating of some features.

Such off-line atmospheric plasma cleaning may take a shorter duration than other known off-line cleaning techniques. Desirably, such off-line atmospheric plasma cleaning may be considered a rapid off-line method.

FIG. 8 depicts an embodiment of a cleaning apparatus 42 that may in particular be used for in-line cleaning of a surface of the fluid confinement structure and/or a component associated with it, such as a surface of a sensor. The embodiment shown has similar features as the embodiment shown in FIG. 7. Variants discussed above in relation to FIG. 7 may be applied to the arrangement depicted in FIG. 8.

The cleaning apparatus may be located in a portion of the substrate table WT, such as a cleaning station. The fluid confinement structure 12 may be moved relative to the substrate table WT so that it is located above the conduit outlet 50 or the substrate table WT may be moved relative to fluid confinement structure 12 so that fluid confinement structure 12 is located above the conduit outlet 50. The cleaning apparatus 42 may have a radical confinement system 40 defined by a portion of the substrate table WT, but it might not have a chamber. The radical confinement system 40 may have a protective gas flow 54 to prevent the radicals from flowing over sensitive areas of the immersion system such as on the fluid confinement structure 12, or an optical element of the projection system, as illustrated in FIG. 8. The radical confinement system 40 may have one or more outlets 56 connected to an under pressure source in order to extract the radicals and to control the flow of the radicals.

As with the arrangement discussed above in relation to FIG. 7, the under pressure source 56 may be arranged such that it results in the space adjacent the cleaning apparatus 42 having a lower pressure than the space in the remainder of the immersion lithographic apparatus. The protective gas flow 54 results. Alternatively or additionally, the cleaning apparatus 42 may comprise one or more outlets 54a connected to a gas source that are specifically configured to provide the protective gas flow 54. Such an arrangement may be particularly beneficial if it is not possible to provide a chamber to limit the flow of radicals from the area to be cleaned.

FIG. 9 depicts an embodiment of part of a cleaning apparatus 42 according to an embodiment of the invention, located underneath a fluid confinement structure. The embodiment may be an off-line embodiment as shown in FIG. 7 where the cleaning apparatus is fitted to the projection system PS, the fluid confinement structure 12 or both. Alternatively or additionally, the embodiment of FIG. 9 may be implemented in an in-line embodiment in which the cleaning apparatus 42 may be in a cleaning station. Variants discussed above in relation to FIGS. 7 and 8 may be applied to the arrangement depicted in FIG. 9.

In the embodiment, the cleaning apparatus 42 may rotate, for example, about the optical axis of the projection system PS so that the undersurface 44 of the fluid confinement structure 12 and/or other component associated with it is cleaned. The cleaning apparatus 42 may have at least two radical confinement systems 40, each having a chamber in which may be located a conduit outlet 50. Each conduit outlet 50 may be associated with a separate plasma generating region 46, as depicted in FIG. 9. Alternatively, one or more conduit outlets 50 may be supplied with radicals by a common plasma generating region 46.

The cleaning apparatus may comprise a single conduit outlet 50 and a single radical confinement system. The cleaning apparatus may be configured, for example, such that it can be rotated 360 degrees about the optical axis of the projection system. In general, the larger the number of conduit outlets 50 that the cleaning apparatus has, the less the cleaning apparatus 42 needs to rotate in order to provide a clean band of the under surface 44 of the fluid confinement structure 12 that completely surrounds the optical axis of the projection system PS. Each chamber may be connected to an under pressure source via one or more outlets 56. Thus, during cleaning, there is a gas flow into the chambers restricting the flow of the radicals to the localized surface being cleaned during cleaning.

FIG. 14 depicts a further arrangement for cleaning the under surface 44 of the fluid confinement structure 12. In this arrangement, the cleaning apparatus 70 includes a main body 71 that is configured such that it may be mounted on the substrate table WT. In particular, the main body 71 may comprise a round plate having the same external cross-sectional dimension (e.g., diameter) as a substrate such that the substrate table WT can support the main body 71 of the cleaning apparatus 70 in the same manner as it supports a substrate without any modification.

The main body is formed from an insulating material and has one or more electrically conducting regions 77 located on the surface of the main body 71 that faces away from the fluid confinement structure 12.

A voltage difference, supplied by a voltage supply 78, is established between the electrically conducting region 77 and at least a part of the fluid confinement structure 12, creating a plasma generating region 72 in the portion of the region between the main body 71 and the fluid confinement structure 12 that is adjacent to the electrically conducting region. The electrically conducting region 77 may be shaped to conform to the shape of a part of the fluid confinement structure 12 to be cleaned.

The voltage required to establish the plasma generating region may depend on the thickness of the main body 71 and, in particular, the separation between the main body and the fluid confinement structure 12. The voltage required may, for example, be between about 50 and 300 V. A varying voltage should be used, such as an AC voltage having a sine wave form. However other voltage patterns may be used. In addition, the voltage may be pulsed, providing time periods in which no voltage is provided. This may reduce heating.

The cleaning apparatus 70 does not include its own gas source to be passed through the plasma generating region 72. Instead, the fluid confinement structure 12 of the immersion lithographic apparatus may be configured to provide the flow of gas which includes a mixture of inert gas and an active gas, as described above. For example, the fluid confinement structure 12 may be configured such that, in a cleaning operation, it is drained of immersion liquid. Subsequently, the gas flow is provided by one or more components of the fluid confinement structure 12 and is supplied to the plasma generating region 72 in order to create the radicals. The fluid confinement structure components may be used during an exposure process to provide and/or control the immersion liquid.

Alternatively or additionally, the fluid confinement structure 12 may be provided with a separate conduit specifically to supply and/or control the flow of gas during a cleaning operation.

The flow of gas provided during the cleaning operation is configured such that it flows through the plasma generating region 72, the location of which may be defined by the location of the electrically conducting region 77, resulting in the generation of radicals in the region in which cleaning is desired.

The flow of gas 73 provided to the plasma generating region 72 by the fluid confinement structure 12 may be configured such that the flow of gas also functions to confine the radicals that are generated. In particular, as shown in FIG. 14, the flow of gas 73 may be arranged to flow from one or more gas inlets 74 providing gas from the fluid confinement structure 12 to the space between the fluid confinement structure 12 and the main body 71 of the cleaning apparatus 70. The gas flow 73 may be extracted from one or more fluid outlets 75 in the fluid confinement structure 12. By the appropriate arrangement of the gas inlets 74 and fluid outlets 75, the gas flow 73 may be configured to flow away from the final element of the projection system PS. This helps ensure that the flow of radicals back to the projection system PS is prevented or significantly reduced when radicals are generated in the plasma generating region 72. By appropriate modification, a similar system may be used to prevent radicals flowing onto one or more other sensitive components.

Power may be supplied to the cleaning apparatus 70 by means of one or more electrodes mounted on the substrate table WT. For example, one or more pins 76 of the substrate table that are used to lift a substrate relative to the substrate table WT in order to enable the substrate to be removed from the substrate table WT, may be connected to an electrical power source. Correspondingly, one or more electrodes may be provided on the under surface of the main body 71 of the cleaning apparatus 70 and connected to the one or more electrically conducting regions 77. The electrodes may be arranged such that the electrical contact of the cleaning apparatus is in contact with the electrical contact of the substrate table when the cleaning apparatus 70 is mounted to the substrate table WT. Actuation to achieve the arrangement may be achieved by operation of a controller.

In addition to radicals, ions may be created in the plasma generating region 72. The damage that may be caused by any such ions may be reduced by controlling the energy of any such ions. This may be achieved, for example, by appropriate selection of the gas and the voltage provided between the electrically conducting region 77 and the fluid confinement structure 12.

An arrangement such as that depicted in FIG. 14, in which the cleaning apparatus may be loaded to the lithographic apparatus for a cleaning process in the same manner as a substrate, may provide a convenient arrangement for rapid cleaning of the under surface 44 of the fluid confinement structure 12. Significant redesign of the immersion lithographic apparatus may not be required. Significant time required to re-configure an immersion lithographic apparatus for the performance of a cleaning process may be avoided. It should be appreciated that although the arrangement depicted in FIG. 14 has been described above in the context of in-line cleaning, for example cleaning at least a part of the lithographic apparatus without opening the lithographic apparatus, the arrangement may also or instead be used for cleaning at least a part of the lithographic apparatus off-line.

FIGS. 16 and 17 depict arrangements that may be used to provide cleaning. These arrangements are similar to that which is discussed above in relation to FIG. 14 and, accordingly, only the differences will be discussed. It should be appreciated that variations of the arrangements discussed above in relation to FIG. 14 may also apply to the arrangements depicted in FIGS. 16 and 17. In particular, the arrangements depicted in FIGS. 16 and 17 as described below may be used for either in-line or off-line cleaning.

As with the arrangement discussed above in relation to FIG. 14, the arrangements depicted in FIGS. 16 and 17 provide a cleaning apparatus 80 that has a main body 81 that is configured such that it may be mounted on the substrate table WT. In particular, the main body 81 may comprise a round plate having the same external cross-section dimension (e.g., diameter) as a substrate such that the substrate table WT can support the main body 81 of the cleaning apparatus 80 in the same manner as it supports a substrate without any modification. The main body 81 is formed from an insulating material, for example Al₂O₃.

Similar to the arrangement depicted in FIG. 14, the cleaning apparatus 81 includes a plurality of electrically conducting regions 82, 83. However, the cleaning apparatus 80 of the arrangements depicted in FIGS. 16 and 17 have two sets of one or more electrically conducting regions 82, 83, each set being connected to associated electrodes 85, 86. A voltage difference may be applied to the electrodes 85, 86, resulting in the establishment of a plasma 87 on the surface 84 of the main body 81 that faces the under surface 44 of the fluid confinement structure 12 and the projection system PS.

It should be appreciated that any convenient arrangement for connecting the electrodes 85, 86 of the cleaning apparatus 80 to a voltage supply may be used. In particular, although not depicted in FIGS. 16 and 17, the electrodes 85, 86 may be mounted onto the surface of the main body 81 that is supported by the substrate table WT. Accordingly, electrical contacts may be provided on the substrate table WT such that they come into contact with the electrodes 85, 86 in order to provide the voltage difference to the cleaning apparatus 80.

It should be appreciated that the voltage applied to the cleaning apparatus 80 may be different to that provided to the cleaning apparatus 70 depicted in FIG. 14. In particular, a voltage difference of several kV may be used. This may enable the cleaning apparatus 80 to be used with a greater range of gases, namely may be used with a gas having a higher ignition voltage.

As shown in FIG. 16, the cleaning apparatus 80 may have one or more first electrically conducting regions 82 on a side of the main body 81 that faces away from the fluid confinement structure 12 and/or the projection system PS. Accordingly, the one or more first electrically conducting regions are electrically isolated from the side of the main body 81 facing the fluid confinement structure 12 and/or projection system PS.

The second set of electrically conducting regions 83 may be formed on the surface 84 of the main body 81 that faces the fluid confinement structure 12 and/or the projection system PS. Although not depicted in FIG. 16, the one or more first electrically conducting regions 82 may be covered by a layer of electrically insulating material.

As depicted in FIG. 17, the cleaning apparatus 80 may be configured such that the first and second regions of electrically conducting material 82, 83 are embedded within the main body 81. Accordingly both sets of electrically conducting regions 82, 83 may be electrically isolated from the side of the main body 81 that faces the fluid confinement structure 12 and/or the projection system PS. Both arrangements depicted in FIGS. 16 and 17 may provide so-called Surface Dielectric Barrier Discharge (SDBD).

An advantage of a cleaning apparatus 80 as depicted in FIGS. 16 and 17 is that the plasma 87 may be generated without providing a voltage difference between the cleaning apparatus 80 and the surface to be cleaned, for example as provided in the arrangement depicted in FIG. 14. Accordingly, a cleaning apparatus 80 such as that depicted in FIGS. 16 and 17 may be used to clean electrically non-conducting materials. Accordingly, for example, the cleaning apparatus 80 depicted in FIGS. 16 and 17 may be used to clean the surface of an optical element of the projection system PS, in particular the surface of the final element or lens of the projection system PS. The final element of an immersion lithographic apparatus may, in particular, require cleaning. For example, if a high NA immersion liquid is used, the liquid may be a hydrocarbon fluid. When UV radiation passes through such a liquid, it may dissociate into carbon and gas. The carbon may coat the surface of the final element and may otherwise be difficult to remove.

The cleaning apparatus 80 as depicted in FIGS. 16 and 17 may be advantageous because it may be possible to provide localized cleaning of, for example, the projection system. In particular, this may be possible because of the ability to confine the generated plasma 87 using a flow of gas, and/or the ability to control the region in which the plasma 87 is formed by appropriate arrangement of the regions of electrically conducting material 82, 83, and/or the ability to control the position of the cleaning apparatus 80 relative to the projection system, for example, using the substrate table WT.

During use of the cleaning apparatus 80 depicted in FIGS. 16 and 17, the surface 84 of the cleaning apparatus 80 may be brought within approximately 0.5 to 2 mm from the surface to be cleaned. With such an arrangement, approximately 4 to 5 μm of contaminant may be removed per minute. Accordingly, it may be possible to clean a surface within a few minutes. Such a cleaning process may be provided periodically. For example, it may be provided regularly or simply when required. In an example, cleaning may be performed between approximately every 15 minutes and every hour.

It should be appreciated that, although the cleaning apparatus 80 depicted in FIGS. 16 and 17 may be particularly beneficial for cleaning an electrically non-conducting component, such as an optical element, it may also or instead be used for cleaning an other part of a lithographic apparatus.

The cleaning apparatus may have the features of the cleaning apparatus as previously described and may be arranged to clean a localized portion of a surface of the substrate table and/or a component associated with the substrate table, such as a surface of a sensor. For example, in arrangements as discussed above in which the cleaning apparatus is mounted to an actuator system, the actuator system may be arranged such that the cleaning apparatus can be moved between a first position and a second position. In the first position, the cleaning apparatus may clean a surface of the fluid confinement structure 12. In the second position, the cleaning apparatus may clean a surface of the substrate table.

Alternatively or additionally, a dedicated cleaning apparatus may be provided for cleaning a surface of the substrate table. The cleaning apparatus may be configured to clean a localized portion of a surface of the substrate table while the substrate table is installed within the immersion lithographic apparatus. A radical confinement system of the cleaning apparatus may be configured so that a localized portion of the substrate table is cleaned without significant leakage of radicals to other parts of the apparatus. Alternatively or additionally, the substrate table may be removable from a region adjacent the fluid confinement structure and the projection system for a cleaning operation. When the substrate table is removed from the region, the cleaning apparatus may be operable to clean the localized surface of the substrate table.

Alternatively or additionally, at least an outlet of the conduit of the cleaning apparatus may be installed within the fluid confinement structure. The outlet may be located in a surface of the fluid confinement structure opposing the substrate table.

FIG. 10 depicts an embodiment of a cleaning apparatus 42 to clean a localized surface of substrate table WT. The cleaning apparatus 42 may have similar features as the embodiments as shown in FIGS. 7, 8 and 9. Variants discussed above in relation to those arrangements may be applied to the cleaning apparatus to clean the substrate table.

A gas source 45 may supply a gas flow. The gas flow may flow through a plasma generating region 46. The plasma generating region may be part of a plasma radical source 46 and may generate radicals which may be entrained by the gas flow. The gas flow is directed through a conduit 48 to the substrate table WT to clean the localized surface of the substrate table WT. The conduit 48 may have an outlet 50 through which the entraining gas is emitted.

The cleaning apparatus 42 may comprise a radical confinement system 40 having a chamber which may restrict the flow of radicals to the localized surface being cleaned. There may be a protective gas flow 54 between the substrate table WT and the radical confinement system 40, into the chamber. The chamber may have an outlet 56 connected to a source of under pressure which may, for example, establish the protective gas flow 54. This embodiment of the cleaning apparatus may be an off-line implementation in which the substrate table WT is removed from the lithographic apparatus. The cleaning apparatus 40 is then fitted to the substrate table WT to clean the substrate table surface. In a variation, the cleaning apparatus WT may be integral to the fluid confinement structure, so that the conduit outlet 50 may be located in the undersurface of the fluid confinement structure.

Many particles observed during operation of the immersion system may be organic. An important primary source is the substrate edge that carries the organic contamination into the immersion lithographic apparatus. During exposure, the contamination will redistribute over various surfaces of the immersion system and over the substrate surface. Due to this contamination the functionality of several parts of the immersion system, such as the gas knife, the single phase extractor and/or sensor functionality may be compromised. Therefore it is desirable for the edge region of a substrate to be cleaned. Known cleaning methods have one or more drawbacks making them difficult to implement and control. For example, physically contacting the substrate can redeposit contaminating particles on the substrate. A contact type cleaner depends on the cleanliness of the cleaning tool and may need replacement. A cleaning technique using liquid may require drying which is problematic for a substrate.

Using a plasma cleaner to clean a surface of a substrate may encounter a problem. A substrate has an organic coating, such as a resist. Known plasma cleaners do not direct the plasma generated radicals to a specific location as the gas flow from the plasma cleaner tends to broaden and spread to flow across the surface being cleaned. Thus there is a risk that the radicals will clean the substrate surface and remove previously created features on the substrate surface. Alternatively or additionally, the characteristics of an as yet unexposed layer of resist may change if exposed to, for example, the radicals. This may have adverse effects on the imaging process or subsequent processing. This problem may be solved by directing the radicals only to parts of substrate surface on which features have not been formed or comprising an as yet unexposed layer of resist. This may be achieved by a gas flow with a component of direction in opposition to the gas flow that entrains the radicals. In this way the radicals clean only the portion of the substrate desired to be cleaned. Desirably, a substrate cleaned by this technique will have an edge with improved defect count density (i.e. defectivity), namely a reduction in defect count density, without the need to have stringent specifications for substrates which are difficult to monitor.

A plasma substrate cleaner 42 may be integrated into an immersion lithographic apparatus, e.g. as part of the substrate handler system, may be part of a stand-alone cleaning apparatus, may be part of a substrate transport system in a substrate fabrication facility and/or may be part of a processing unit that at least one selected from the following: applies resist to a substrate, heats a substrate, chills a substrate or develops resist on a substrate. The plasma cleaner may be used to rapidly remove organic contamination from the bevel and apex area of the substrate W.

The cleaning apparatus may have any of the aforementioned features of the cleaning apparatus previously described, for example for cleaning a fluid confinement structure/system and/or substrate table.

The cleaning apparatus may comprise a substrate rotator. The substrate rotator may be configured to rotate a substrate relative to the conduit. Alternatively, at least a part of the cleaning apparatus may be configured to rotate about the substrate. A radical confinement system may be configured to direct the radicals to a localized portion of the periphery of the substrate. So, by rotation of the substrate relative to the conduit, the complete periphery of the substrate may be cleaned.

The conduit may direct the radicals onto a portion of the edge of the substrate. The conduit may direct the radicals onto a peripheral portion of a major face of the substrate on which devices are to be formed. The radical confinement system may comprise a protective gas source configured to provide a gas flow in opposition to a flow of radicals from the conduit along a major surface of the substrate to limit the extent to which the radicals pass onto the surface of the substrate. The radical confinement system may comprise a gas extractor. The gas extractor may be located between the conduit and the protective gas source. The gas extractor may be arranged to extract radicals from the conduit and gas flow from the protective gas source.

The cleaning apparatus may comprise a substrate holder configured to hold the substrate. The substrate rotator may be configured to rotate both the substrate holder and substrate relative to the conduit. Alternatively, or additionally, the substrate holder may comprise a substrate mount configured to support the substrate. The substrate rotator may be configured to rotate the substrate relative to the substrate mount. The substrate rotator may be configured to support the substrate during cleaning. The substrate rotator may be configured such that, in one mode it is operable to rotate the substrate relative to the conduit. The substrate rotator may have one or more other modes in which it is operable move the substrate between at least two locations, for example it may include an actuator to move the substrate between a cleaning location and a load/unload position.

In a particular arrangement, a lithographic apparatus may comprise a substrate handler and a substrate cleaner. The substrate hander may be configured to position a substrate on a substrate table to support the substrate during exposure. The substrate handler may be configured to rotate the substrate prior to positioning the substrate on the substrate table. The substrate cleaner may be configured to clean a localized portion of the substrate surface as the substrate rotates.

The plasma cleaner may comprise a plasma radical source, a conduit and a radical confinement system similar to those discussed above. The plasma radical source may provide a flow of radicals. The conduit may be configured to supply radicals from the plasma radical source to the surface to be cleaned. The radical confinement system may direct the radicals to clean the portion.

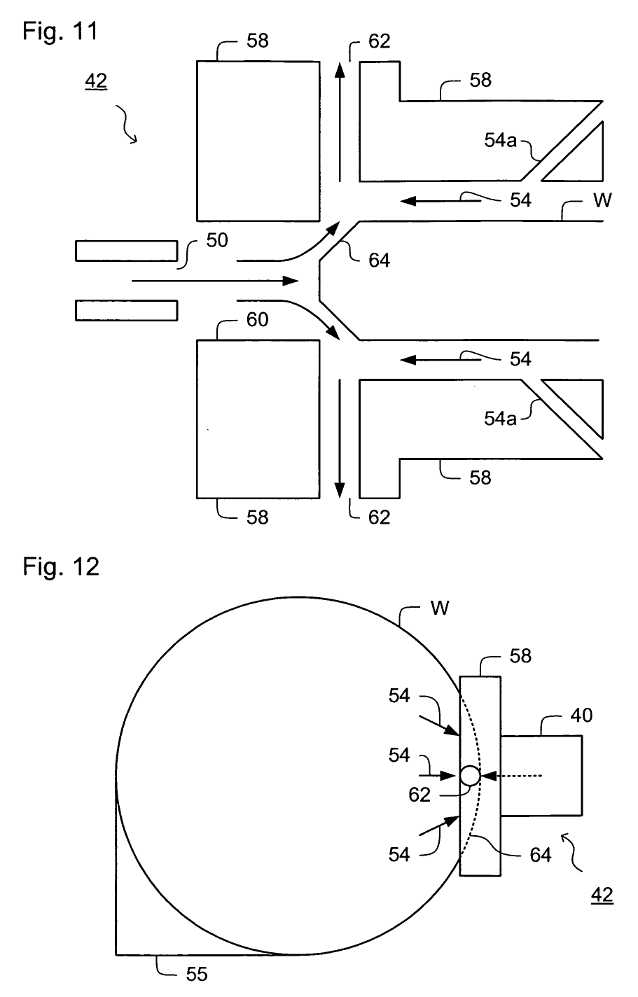

FIG. 11 depicts a cross-section through an embodiment of a cleaning apparatus 42 for cleaning an edge 64 of a substrate W; and FIG. 12 depicts the same cleaning apparatus and a substrate handler 55 in plan view. This embodiment of the cleaning apparatus has similar features to those shown in FIGS. 7 to 10, including, but not limited to: a gas source 45 (not shown for clarity), a plasma radical source 46 (not shown for clarity), a conduit 48 (not shown for clarity), a conduit outlet 50 and a radical confinement system 40. Variations discussed above in relation to those arrangements may be applied to the apparatus depicted in FIGS. 11 and 12 as appropriate.

In the present embodiment the radical confinement system 40 comprises a substrate enclosure 58 enclosing the portion of the substrate W being cleaned. The substrate enclosure 58 may have an aperture 60 which may be in the form of a slit. The aperture 60 may restrict access of the gas flow entraining the radicals to the peripheral portion of the substrate W, including the edge 64 of the substrate W. Thus the edge region 64 of the substrate W may be cleaned. The enclosure 58 may be configured so that a protective gas flow 54 is directed towards the flow of radicals, parallel to a major surface of the substrate W. The protective gas flow 54 may be sufficient to restrict the radicals to the surface required to be cleaned. The protective gas flow 54, may, for example, be provided by one or more gas conduits 54a within the substrate enclosure 58 that are connected to a gas supply.

At the edge 64 of the substrate W, substantially perpendicular to a major surface of the substrate W may be one or more outlets 62 connected to an under pressure source. In FIG. 11 there are two such outlets 62 located in opposite directions. The under pressure may act to remove gas from the substrate enclosure 58, such as exhaust gas, and draw in the gas entraining the radicals into the substrate enclosure 58. Alternatively or additionally, the under pressure may draw in gas to the space between the substrate enclosure 58 and the substrate W, providing the protective flow of gas 54.

The substrate enclosure 58 may be adjustable, so that it can be accurately positioned relative to the substrate W surface and the conduit outlet 50 so that a sharp clearly defined portion of the substrate surface is cleaned. Adjusting the position of substrate enclosure 58 relative to the surface of the substrate W may help ensure that there is no contact between the substrate W and the substrate enclosure 58, especially during rotation of the substrate W, minimizing the risk of damage to the substrate W and/or any features that have already been formed on the substrate W.

Alternatively or additionally, adjusting the separation between the surface of the substrate W and the substrate enclosure 58 may be used to adjust the size of the gap between them, adjusting the flow rate of the protective gas flow 54. This may provide a further tool for adjusting the extent to which the radicals pass over the surface of the substrate W.

During the cleaning process, the cleaner 42 may be held by a substrate rotator. The rotator may rotate, rotating the substrate W about its axis. Accordingly during cleaning, the complete periphery of the substrate W may be cleaned. The rotator may be configured to handle the substrate W to move the substrate between two locations, for example from the substrate stack to a substrate cleaning position, or from the cleaning position to the substrate table WT for exposure, or from the substrate table WT back to the substrate stack.

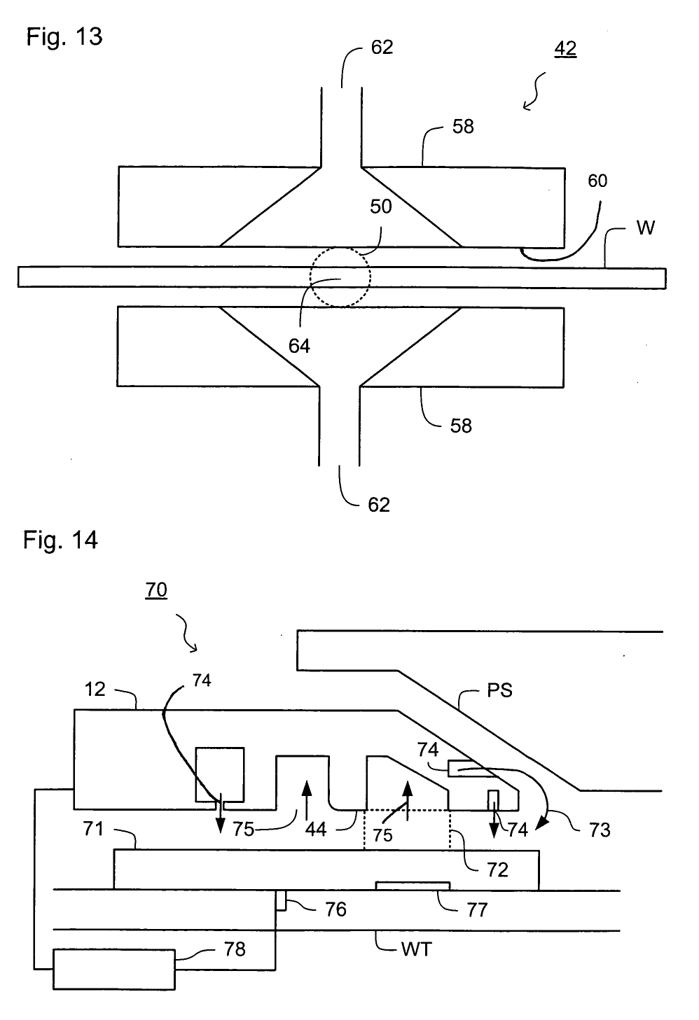

FIG. 13 depicts another view of the embodiment of part of a substrate W and a cleaning apparatus 42 configured to clean the surface of a substrate W. FIG. 13 shows the relative positions of the substrate W, substrate enclosure 58, opposing outlets 62 and the conduit outlet 50.

This embodiment may be beneficial because the part of the substrate to which the plasma generated radicals are not intended to be directed may be shielded and a plume of radicals in the gas flow may be confined or directed.

It should be appreciated that, in addition or alternatively to cleaning the surface of a substrate, the cleaning apparatus may be used to remove contaminants from a layer formed on a substrate, such as a protective layer or membrane formed on an edge seal on a substrate.

Variations of the described embodiment may achieve the same outcome. The embodiment may be varied in a number of ways. The settings of the plasma source and/or the entraining gas flow (i.e. the speed of the radicals emitted from conduit) may be adjusted. The conduit outlet or substrate enclosure aperture geometry may be altered (e.g. the aperture may have a shape other than a slit). The distance between the surface of the substrate and the substrate enclosure may be changed. It may be desirable that the substrate enclosure is as close as possible to the substrate surface (e.g. 100 μm). The distance between the substrate and the edge may be varied depending upon the specific conditions. The under pressure may be varied, as may the flow rate of the protective gas and the geometry and the configuration of the radical confinement system and substrate enclosure.

Using the cleaning apparatus to clean a substrate edge, desirably, there may be no, or minimal, damage to structures or unexposed resist on the substrate by uncontrolled radical activity. However the technique may remove resist, like contamination, within a short time. A surface that could be damaged by oxidizing species may be treated with radicals generated by a reducing plasma, for example with a hydrogen concentration of 1% hydrogen. The cleaning does not require of use chemicals that may leave drying stains. The method is contactless, so that there may be no physical damage risk to a three dimensional surface.

In an embodiment, there is provided an apparatus for cleaning a substrate or component of an immersion lithographic apparatus comprising a substrate table for supporting a substrate and a fluid confinement system for confining immersion fluid between a projection system and substrate table and/or substrate, the cleaning apparatus comprising: a plasma radical source providing a flow of radicals; a conduit for supplying radicals from the plasma radical source to the surface to be cleaned; and a radical confinement system for directing the radicals to clean a localized portion of the surface.

In an embodiment, the radical confinement system comprises a barrier member.

In an embodiment, the radical confinement system is configured to provide a flow of gas so as to limit the radicals substantially to the same side of the barrier member as the localized portion of the surface.

In an embodiment, the barrier member is a radical confinement chamber within which an outlet of the conduit is located.

In an embodiment, the radical confinement chamber comprises an outlet connected to an under pressure source.

In an embodiment, the plasma radical source is located between approximately 1 mm and approximately 30 mm from the surface to be cleaned.

In an embodiment, the radical confinement system is configured to form a gas flow to direct the radicals.

In an embodiment, the plasma radical source is configured to supply a source of reducing radicals.

In an embodiment, the plasma radical source is configured to supply a source of oxidizing radicals.

In an embodiment, the plasma radical source comprises a gas source and a plasma generating region; and the plasma radical source is configured to supply gas from the gas source so as to pass through the plasma generating region to the conduit.

In an embodiment, the plasma generating region comprises a high temperature element located within a path of the flow of gas, the temperature of the high temperature element being sufficient to cause thermal dissociation to create the radicals.

In an embodiment, the gas source provides a supply of purified air.

In an embodiment, the plasma generating region comprises a RF coil, a pair of AC or DC discharge electrodes, and/or a microwave or RF cavity to generate a region of plasma within the flow of gas from the gas source, the radicals being formed in the plasma region.

In an embodiment, the gas source provides a mixture of an inert gas and an active gas; wherein the inert gas is at least one selected from: nitrogen, helium, argon, neon or xenon; and the active gas is oxygen and/or hydrogen.

In an embodiment, the active gas is between approximately 0.5% and approximately 2%, and desirably approximately 1%, of the gas supplied by the gas source.

In an embodiment, the plasma radical source and the conduit are configured such that substantially no ions are provided from the conduit.

In an embodiment, the cleaning apparatus further comprises a rotator, configured to rotate a substrate relative to the conduit, and wherein the radical confinement system is configured to direct the radicals to a localized portion of the periphery of the substrate such that, by rotation of the substrate relative to the conduit, the complete periphery of the substrate may be cleaned.

In an embodiment, the conduit directs the radicals onto a portion of the edge of the substrate.

In an embodiment, the conduit directs the radicals onto a peripheral portion of a major face of the substrate on which devices are to be formed.

In an embodiment, the radical confinement system comprises a protective gas source configured to provide a gas flow in opposition to a flow of radicals from the conduit along a major surface of the substrate to limit the extent to which the radicals pass onto the surface of the substrate.

In an embodiment, the radical confinement system comprises a gas extractor, located between the conduit and the protective gas source, and arranged to extract radicals from the conduit and gas flow from the protective gas source.

In an embodiment, the cleaning apparatus further comprises a substrate holder configured to hold the substrate, and wherein the rotator is configured to rotate the substrate holder relative to the conduit.

In an embodiment, the cleaning apparatus further comprises a substrate mount configured to support the substrate, and wherein the rotator is configured to rotate the substrate relative to the substrate mount.

In an embodiment, the rotator is configured to support the substrate during cleaning.

In an embodiment, the rotator is configured such that, in one mode, it is operable to rotate the substrate relative to the conduit and, in at least one other mode, it is operable move the substrate between locations.

In an embodiment, the cleaning apparatus is installed within at one selected from the following: a lithographic apparatus, a transport unit configured to transport a substrate, or a substrate processing unit configured to at least one selected from the following: coat a substrate with a resist, bake a substrate, cool a substrate or develop a layer of resist on a substrate that has been exposed with a patterned beam of radiation.

In an embodiment, there is provided an immersion lithographic apparatus comprising:

a projection system for imparting a patterned beam onto a substrate;

a fluid confinement structure for confining immersion fluid between the projection system and the substrate and/or a substrate table, the substrate table for supporting a substrate; and

a cleaning apparatus as above, arranged to clean a localized portion of a surface of the fluid confinement structure.

In an embodiment, the cleaning apparatus is configured to clean the localized portion of a surface of the fluid confinement structure while the fluid confinement structure is installed within the immersion lithographic apparatus; and the radical confinement system of the cleaning apparatus is configured to prevent radicals from being directed onto an element of the projection system.

In an embodiment, the immersion lithographic apparatus comprises a substrate table, configured such that the substrate table is removable from the region adjacent the fluid confinement structure and the projection system; and, when the substrate table is removed from the region, the cleaning apparatus is operable to clean the localized portion of a surface of the fluid confinement structure.

In an embodiment, the immersion lithographic apparatus comprises a substrate table, wherein at least an outlet of the conduit of the cleaning apparatus is installed within the substrate table.

In an embodiment, the fluid confinement structure surrounds an element of the projection system and the cleaning apparatus is configured to clean a band on a surface of the fluid confinement structure that surrounds the element of the projection system.

In an embodiment, the outlet of the conduit supplying the radicals is configured to conform to the shape of the band to be cleaned.

In an embodiment, a plurality of plasma radical sources are arranged to provide radicals to the conduit.

In an embodiment, there is provided an immersion lithographic apparatus comprising:

a projection system for imparting a patterned beam onto a substrate;

a substrate table for supporting the substrate;

a fluid confinement structure for confining immersion fluid between the projection system and the substrate and/or the substrate table; and

a cleaning apparatus as above, arranged to clean a localized portion of a surface of the substrate table.

In an embodiment, the cleaning apparatus is configured to clean the localized portion of a surface of the substrate table while the substrate table is installed within the immersion lithographic apparatus; and the radical confinement system of the cleaning apparatus is configured to clean a localized portion of the substrate table.

In an embodiment, the substrate table is removable from a region adjacent the fluid confinement structure and the projection system; and, when the substrate table is removed from the region, the cleaning apparatus is operable to clean the localized surface of the substrate table.

In an embodiment, at least an outlet of the conduit of the cleaning apparatus is installed within the fluid confinement structure.

In an embodiment, there is provided an lithographic apparatus comprising:

a substrate handler configured to position a substrate on a substrate table for supporting the substrate during exposure, the substrate handler configured to rotate the substrate prior to positioning the substrate on the substrate table; and

a substrate cleaner configured to clean a localized portion of the substrate surface as the substrate rotates, the plasma cleaner comprising: a plasma radical source providing a flow of radicals; a conduit for supplying radicals from the plasma radical source to the surface to be cleaned: and a radical confinement system for directing the radicals to clean the portion.

In an embodiment, there is provided a cleaning apparatus for cleaning a surface of an immersion lithographic apparatus comprising a substrate table for supporting a substrate and a fluid confinement structure for confining immersion fluid between a projection system and a substrate table and/or a substrate, the cleaning apparatus comprising:

a main body, formed of an electrically insulating material and configured to be supported by the substrate table of the immersion lithographic apparatus in place of a substrate; and

a first electrically conducting region formed such that it is electrically isolated by at least a part of the main body from a surface of the main body that faces the fluid confinement structure when the main body is supported on the substrate table.

In an embodiment, the main body comprises a second electrically conducting region that is electrically isolated from the first electrically conducting region.

In an embodiment, the second electrically conducting region is formed on a surface of the main body that faces the fluid confinement structure when the main body is supported on the substrate table.

In an embodiment, the second electrically conducting region is formed such that it is electrically isolated by at least a part of the main body from a surface of the main body that faces the fluid confinement structure when the main body is supported on the substrate table.

In an embodiment, there is provided an immersion lithographic apparatus comprising:

a projection system for imparting a patterned beam onto a substrate;

a substrate table, configured to support a substrate;

an fluid confinement structure for confining immersion fluid between the projection system and the substrate and/or a substrate table; and

a voltage supply, configured to supply a voltage between the fluid confinement structure and an electrically conducting region on the main body of a cleaning apparatus as above when it is supported on the substrate table.

In one embodiment, there is provided an immersion lithographic apparatus comprising:

a projection system for imparting a patterned beam onto a substrate;

a substrate table, configured to support a substrate;

an fluid confinement structure for confining immersion fluid between the projection system and the substrate and/or substrate table; and

a voltage supply, configured to supply a voltage between the first and second electrically conducting regions of the main body of a cleaning apparatus as above when it is supported on the substrate table.

In an embodiment, the fluid confinement structure is configured to be switchable between an exposing state, in which it confines immersion fluid between the projection system and the substrate and/or the substrate table, and a cleaning state, in which it provides a flow of gas between the fluid confinement structure and the substrate table; and the immersion lithographic apparatus is configured such that, when the substrate table supports the cleaning apparatus and the fluid confinement structure is switched to the cleaning state, the substrate table is positioned such that the flow of gas provided by the fluid confinement structure passes through a region adjacent the first electrically conducting region and the voltage supplied between the first electrically conducting region and the liquid confinement structure generates radicals in the region.

In an embodiment, the fluid confinement structure is configured to be connected to a gas supply to provide the flow of gas, wherein the gas is a mixture of an inert gas and an active gas.

In an embodiment, the inert gas is at least one selected from the following: nitrogen, helium, argon, neon or xenon; and the active gas is oxygen and/or hydrogen.

In an embodiment, the gas is purified air.

In an embodiment, the substrate table comprises an electrode connected to the voltage supply and configured to contact a corresponding electrode on the cleaning apparatus that is further connected to the first electrically conducting region.

In an embodiment, the fluid confinement structure is configured such that, when it is in the cleaning state, the flow of gas provided by the fluid confinement structure and that passes into the region adjacent the first electrically conducting region is flowing in a direction away from the projection system.

In an embodiment, there is provided a method for cleaning a substrate or component of an immersion lithographic apparatus, the immersion lithographic apparatus comprising a substrate table for supporting a substrate and a fluid confinement structure for confining immersion fluid between a projection system and substrate table and/or substrate, the method comprising:

providing a flow of radicals using a plasma radical source;

supplying radicals from the plasma radical source to the surface to be cleaned using a conduit; and

directing the radicals to clean a localized portion of the surface using a radical confinement system.

In an embodiment, there is provided a method for cleaning a surface of an immersion lithographic apparatus, the immersion lithographic apparatus comprising a substrate table for supporting a substrate and a fluid confinement structure for confining immersion fluid between a projection system and a substrate table and/or a substrate, the method comprising:

supporting on the substrate table a cleaning apparatus, the cleaning apparatus comprising a main body, configured to be supported by the substrate table of the immersion lithographic apparatus in place of a substrate, and a plasma radical generator, configured to generate radicals within gas in a region adjacent the plasma radical generator; and

using the fluid confinement structure to provide a flow of gas between the fluid confinement structure and the substrate table,

wherein the flow of gas provided by the fluid confinement structure passes through the region adjacent the plasma radical generator such that a supply of radicals is provided.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of or about 365, 248, 193, 157 or 126 nm).

The term “lens”, where the context allows, may refer to any one or combination of various types of optical components, including refractive and reflective optical components.

While specific embodiments of the invention have been described above, it will be appreciated that the invention may be practiced otherwise than as described. For example, the embodiments of the invention may take the form of a computer program containing one or more sequences of machine-readable instructions describing a method as disclosed above, or a data storage medium (e.g. semiconductor memory, magnetic or optical disk) having such a computer program stored therein. Further, the machine readable instruction may be embodied in two or more computer programs. The two or more computer programs may be stored on one or more different memories and/or data storage media.

The controllers described above may have any suitable configuration for receiving, processing, and sending signals. For example, each controller may include one or more processors for executing the computer programs that include machine-readable instructions for the methods described above. The controllers may also include data storage medium for storing such computer programs, and/or hardware to receive such medium.

One or more embodiments of the invention may be applied to any immersion lithography apparatus, in particular, but not exclusively, those types mentioned above and whether the immersion liquid is provided in the form of a bath, is confined to a localized surface area of the substrate, or is unconfined. In an unconfined arrangement, the immersion liquid may flow over the surface of the substrate and/or substrate table so that substantially the entire uncovered surface of the substrate table and/or substrate is wetted. In such an unconfined immersion system, the liquid supply system may not confine the immersion liquid or it may provide a proportion of immersion liquid confinement, but not substantially complete confinement of the immersion liquid.

A liquid supply system as contemplated herein should be broadly construed. In certain embodiments, it may be a mechanism or combination of structures that provides a liquid to a space between the projection system and the substrate and/or substrate table. It may comprise a combination of one or more structures, one or more liquid inlets, one or more gas inlets, one or more gas outlets, and/or one or more liquid outlets that provide liquid to the space. In an embodiment, a surface of the space may be a portion of the substrate and/or substrate table, or a surface of the space may completely cover a surface of the substrate and/or substrate table, or the space may envelop the substrate and/or substrate table. The liquid supply system may optionally further include one or more elements to control the position, quantity, quality, shape, flow rate or any other features of the liquid.

The immersion liquid used in the apparatus may have different compositions, according to the desired properties and the wavelength of exposure radiation used. For an exposure wavelength of 193 nm, ultra pure water or water-based compositions may be used and for this reason the immersion liquid is sometimes referred to as water and water-related terms such as hydrophilic, hydrophobic, humidity, etc. may be used, although they should be considered more generically. It is intended that such terms should also extend to other high refractive index liquids which may be used, such as fluorine containing hydrocarbons.

The descriptions above are intended to be illustrative, not limiting. Thus, it will be apparent to one skilled in the art that modifications may be made to the invention as described without departing from the scope of the claims set out below.

1. A cleaning apparatus to clean a substrate or a component of an immersion lithographic apparatus, the lithographic apparatus comprising a substrate table to support a substrate and a fluid confinement system to at least partly confine immersion fluid between a projection system and the substrate table and/or substrate, the cleaning apparatus comprising:
a plasma radical source configured to provide a flow of radicals;
a conduit to supply radicals from the plasma radical source to the surface to be cleaned; and
a radical confinement system to direct the radicals to clean a localized portion of the surface.

2. The cleaning apparatus of claim 1, wherein the radical confinement system comprises a barrier member.

3. The cleaning apparatus of claim 2, wherein the radical confinement system is configured to provide a flow of gas so as to limit the radicals substantially to the same side of the barrier member as the localized portion of the surface.

4. The cleaning apparatus of claim 2, wherein the barrier member is a radical confinement chamber within which an outlet of the conduit is located.

5. The cleaning apparatus of claim 4, wherein the radical confinement chamber comprises an outlet connected to an under pressure source.

6. The cleaning apparatus of claim 1, wherein the plasma radical source is located between approximately 1 mm and approximately 30 mm from the surface to be cleaned.

7. The cleaning apparatus of claim 1, wherein the radical confinement system is configured to form a gas flow to direct the radicals.

8. The cleaning apparatus of claim 1, wherein the plasma radical source is configured to supply a source of reducing radicals.

9. The cleaning apparatus of claim 1, wherein the plasma radical source is configured to supply a source of oxidizing radicals.

10. The cleaning apparatus of claim 1, wherein the plasma radical source comprises a gas source and a plasma generating region, and the plasma radical source is configured to supply gas from the gas source so as to pass through the plasma generating region to the conduit.

11. The cleaning apparatus of claim 10, wherein the plasma generating region comprises a high temperature element located within a path of the flow of gas, the temperature of the high temperature element being sufficient to cause thermal dissociation to create the radicals.

12. The cleaning apparatus of claim 11, wherein the gas source is configured to supply purified air.

13. The cleaning apparatus of claim 10, wherein the plasma generating region comprises a RF coil, a pair of AC or DC discharge electrodes, and/or a microwave or RF cavity to generate a region of plasma within the flow of gas from the gas source, the radicals being formed in the plasma region.

14. The cleaning apparatus of claim 13, wherein the gas source provides a mixture of an inert gas and an active gas, wherein the inert gas is at least one gas selected from the following: nitrogen, helium, argon, neon or xenon, and the active gas is oxygen and/or hydrogen.

15. The cleaning apparatus of claim 14, wherein the active gas is between approximately 0.5% and approximately 2% of the gas supplied by the gas source.

16. The cleaning apparatus of claim 1, wherein the plasma radical source and the conduit are configured such that substantially no ions are provided from the conduit.

17. The cleaning apparatus according to claim 1, further comprising a rotator configured to rotate a substrate relative to the conduit, and wherein the radical confinement system is configured to direct the radicals to a localized portion of the periphery of the substrate such that, by rotation of the substrate relative to the conduit, the complete periphery of the substrate may be cleaned.

18. The cleaning apparatus according to claim 17, wherein the conduit is configured to direct the radicals onto a portion of the edge of the substrate.

19. The cleaning apparatus according to claim 17, wherein the conduit is configured to direct the radicals onto a peripheral portion of a major face of the substrate on which devices are to be formed.

20. The cleaning apparatus according to claim 17, wherein the radical confinement system comprises a protective gas source configured to provide a gas flow in opposition to a flow of radicals from the conduit along a major surface of the substrate to limit the extent to which the radicals pass onto the surface of the substrate.

21. The cleaning apparatus according to claim 20, wherein the radical confinement system comprises a gas extractor, located between the conduit and the protective gas source, and arranged to extract radicals from the conduit and gas-flow from the protective gas source.

22. The cleaning apparatus according to claim 17, further comprising a substrate holder configured to hold the substrate, and wherein the rotator is configured to rotate the substrate holder relative to the conduit.

23. The cleaning apparatus according to claim 17, further comprising a substrate mount configured to support the substrate, and wherein the rotator is configured to rotate the substrate relative to the substrate mount.

24. The cleaning apparatus according to claim 17, wherein the rotator is configured to support the substrate during cleaning.

25. The cleaning apparatus according to claim 17, wherein the rotator is configured such that, in one mode, it is operable to rotate the substrate relative to the conduit and, in at least one other mode, it is operable move the substrate between locations.

26. The cleaning apparatus according to claim 17, installed within at least one selected from the following: a lithographic apparatus, a transport unit configured to transport a substrate, or a substrate processing unit configured to at least one selected from the following:
coat a substrate with a resist, bake a substrate, cool a substrate or develop a layer of resist on a substrate that has been exposed with a patterned beam of radiation.

27. An immersion lithographic apparatus comprising:
a projection system configured to impart a patterned beam onto a substrate;
a fluid confinement structure configured to at least partly confine immersion fluid between the projection system and the substrate and/or a substrate table, the substrate table arranged to support a substrate; and
a cleaning apparatus to clean a localized portion of a surface of the fluid confinement structure, the cleaning apparatus comprising:
a plasma radical source configured to provide a flow of radicals;
a conduit to supply radicals from the plasma radical source to the surface; and
a radical confinement system to direct the radicals to clean the localized portion of the surface.

28. An immersion lithographic apparatus comprising:
a projection system configured to impart a patterned beam onto a substrate;
a substrate table configured to support the substrate;
a fluid confinement structure configured to at least partly confine immersion fluid between the projection system and the substrate and/or substrate table; and
a cleaning apparatus to clean a localized portion of a surface of the substrate table, the cleaning apparatus comprising:
a plasma radical source configured to provide a flow of radicals;
a conduit to supply radicals from the plasma radical source to the surface; and
a radical confinement system to direct the radicals to clean the localized portion of the surface.

29. A lithographic apparatus comprising:
a substrate handler configured to position a substrate on a substrate table, the substrate table configured to support the substrate during exposure and the substrate handler configured to rotate the substrate prior to positioning the substrate on the substrate table; and
a substrate cleaner configured to clean a localized portion of a surface of the substrate as the substrate rotates, the substrate cleaner comprising: a plasma radical source configured to provide a flow of radicals, a conduit to supply radicals from the plasma radical source to the surface, and a radical confinement system configured to direct the radicals to clean the localized portion.

30. A cleaning apparatus to clean a surface of an immersion lithographic apparatus comprising a substrate table to support a substrate and a fluid confinement structure to at least partly confine immersion fluid between a projection system and a substrate table and/or a substrate, the cleaning apparatus comprising:
a main body, formed of an electrically insulating material and configured to be supported by the substrate table of the immersion lithographic apparatus in place of a substrate; and
an electrically conducting region formed such that it is electrically isolated by at least a part of the main body from a surface of the main body that faces the fluid confinement structure when the main body is supported on the substrate table.

31. An immersion lithographic apparatus comprising:
a projection system configured to impart a patterned beam onto a substrate;
a substrate table configured to support the substrate;
a fluid confinement structure configured to at least partly confine immersion fluid between the projection system and the substrate and/or substrate table; and
a voltage supply, configured to supply a voltage between the fluid confinement structure and an electrically conducting region of a main body of a cleaning apparatus when the main body is supported, in place of a substrate, on the substrate table, the cleaning apparatus comprising:
the main body, formed of an electrically insulating material, and
the electrically conducting region formed such that it is electrically isolated by at least a part of the main body from a surface of the main body that faces the fluid confinement structure when the main body is supported on the substrate table.

32. The immersion lithographic apparatus of claim 31, wherein the electrically conducting region is a first electrically conducting region and wherein the voltage supply is configured to supply a voltage between the first electrically conducting region and a second electrically conducting region of a main body of a cleaning apparatus when the main body is supported, in place of a substrate, on the substrate table, the cleaning apparatus further comprising the second electrically conducting region that is electrically isolated from the first electrically conducting region.

33. A method for cleaning a substrate or component of an immersion lithographic apparatus, the immersion lithographic apparatus comprising a substrate table configured to support a substrate and a fluid confinement structure configured to at least partly confine immersion fluid between a projection system and the substrate table and/or a substrate, the method comprising:
providing a flow of radicals using a plasma radical source;
supplying radicals from the plasma radical source to the surface to be cleaned using a conduit; and
directing the radicals to clean a localized portion of the surface using a radical confinement system.

34. A method for cleaning a surface of an immersion lithographic apparatus, the immersion lithographic apparatus comprising a substrate table configured to support a substrate and a fluid confinement structure configured to at least partly confine immersion fluid between a projection system and the substrate table and/or a substrate, the method comprising:
supporting on the substrate table, in place of a substrate, a main body of a cleaning apparatus, the cleaning apparatus comprising a plasma radical generator, the plasma radical generator configured to generate radicals within gas in a region adjacent the plasma radical generator; and
using the fluid confinement structure to provide a flow of gas between the fluid confinement structure and the substrate table,
wherein the flow of gas provided by the fluid confinement structure passes through the region adjacent the plasma radical generator such that a supply of radicals is provided.
